(19) United States
(12) Patent Application Publication
(10) Pub. No.: US 2021/0124843 A1
(43) Pub. Date: Apr. 29, 2021

(54) SYSTEMS AND METHODS RELATED TO THE UTILIZATION, MAINTENANCE, AND PROTECTION OF PERSONAL DATA BY CUSTOMERS

(71) Applicant: GENESYS TELECOMMUNICATIONS LABORATORIES, INC., DALY CITY, CA (US)

(72) Inventors: TIBOR VASS, MISSION VIEJO, CA (US); SERGIO CORETTI, MIAMI, FL (US); MERIJN teBOOIJ, BURLINGAME, CA (US); BRUNO EDUARDO DONATO BERTINI, MIAMI, FL (US); CHRISTOPHER CONNOLLY, RALEIGH, NC (US)

(73) Assignee: GENESYS TELECOMMUNICATIONS LABORATORIES, INC., DALY CITY, CA (US)

(21) Appl. No.: 17/084,559

(22) Filed: Oct. 29, 2020

Related U.S. Application Data
(60) Provisional application No. 62/927,432, filed on Oct. 29, 2019.

(51) Int. Cl. G06F 21/62; G06F 16/23; G06Q 30/02; G06Q 30/06; G06Q 20/40; G06Q 20/38; G06Q 50/26; G06Q 50/00; G06N 20/00; G06F 40/40

(52) U.S. Cl. CPC G06F 21/6254; G06F 16/2379; G06Q 30/0201; G06Q 30/0613; G06Q 20/405; G06Q 20/383; G06F 40/205; G06Q 50/01; G06Q 30/0269; G06Q 30/0203; G06N 20/00; G06F 40/40; G06Q 50/265

(57) ABSTRACT

A method for protecting personal data pursuant to behavioral factors unique to a first customer. The method includes: storing a customer profile of the first customer that includes transaction data from transactions with entities; providing a personal assistant that is configured to access the customer profile pursuant to engagement rules to conduct the transactions; updating the customer profile pursuant to a first new transaction; generating a predictor from the updated customer profile, the predictor including knowledge about the first customer derived from the updated customer profile including a behavioral factors attributable to the first customer given a characteristic related to the first new transaction; augmenting the customer profile by storing therein the predictor, wherein the predictor: modifies at least one of the rules of the engagement rules and links the behavioral factor to the characteristic of the first transaction.

### CROSS REFERENCE TO RELATED APPLICATION

This application claims the benefit of U.S. Provisional Patent Application No. 62/927,432, titled “VIRTUAL EXPERIENCE TRUST”, filed in the U.S. Patent and Trademark Office on Oct. 29, 2019, the contents of which are incorporated herein.

### BACKGROUND

The present invention generally relates to telecommunications systems in the field of customer relations in the digital marketplace. More particularly, but not by way of limitation, the present invention pertains to systems and methods for automating aspects of the customer experience, including AI-automated personalized assistance in storing, protecting, managing, and utilizing customer or personal data on behalf of a customer or individual.

In today's data and media rich environment, customers are constantly targeted by marketing campaigns related to the multitudes of available products and services. Such marketing campaigns can include robocalls, emails, direct messages, mail, text, and other targeted advertising Merchants try to pursue any and all possible avenues to persuade customers to buy their products, to the extent that it becomes burdensome on the customer. Making matters worse, the abundance of available personal data allows marketers to accumulate multiply datapoints around most every consumer—phone number, email address, physical address, purchasing history, interests, real-time intents, and so on—which are then used to find new ways to contact them. A significant problem with this is that customers have little control or ownership over their own personal data. Customers feel that they are not able to oversee the sharing of their personal data nor restrict unwanted contacts.

Exacerbating this issue is the growing power of AI and the collection of ever more data. Digital merchants now leverage AI and this data to stitch together more and more data to describe customers so that customers may be targeted even more often and in new ways. This unbalanced use of AI technology represents an unfair advantage for the companies and merchants, who are not merely offering alternatives to customers with the use of AI technology, but often persuading or influencing customers to behave in ways that are against their own interests. However, the choice for a customer to refrain from sharing aspects of their personal data is not a practicable solution either, as to do would prevents the customers from leveraging the new opportunities provided in the digital marketplace.

As provided herein, systems and methods are proposed by which customer data may be gathered, maintained, and protected in a secure database and then managed and used on customer's behalf via a personalized data custodian application. As will be seen, this data custodian is directed more toward empowering customers to own and control their own personal data in a secure environment while also selectively sharing that data so to leverage the new opportunities available to consumers in the ever-growing digital marketplace.

### BRIEF DESCRIPTION OF THE INVENTION

The present invention includes a computer-implemented method for personalizing protection of personal data pursuant to behavioral factors unique to an individual customer (hereafter “first customer”). The behavioral factors may be learned from transaction data describing respective transactions occurring between the first customer and entities via a communication device of the first customer. The method may include: storing, in a secured data vault, a customer profile of the first customer that includes personal data of the first customer and the transaction data from each of the transactions; providing a personal assistant application (hereafter “personal assistant”) accessible to the first customer via the communication device, wherein the personal assistant is configured to access the personal data of the first customer in the customer profile pursuant to engagement rules in order to conduct the transactions with the entities on behalf of the first customer; updating the customer profile pursuant to newly occurring ones of the transactions (hereafter “new transactions”), the new transactions including a first new transaction occurring between the first customer and a first one of the entities (hereafter “first entity”); generating a predictor from the updated customer profile, the predictor including knowledge about the first customer derived, at least in part, from the data stored within the updated customer profile, the knowledge including a first one of the behavioral factors (hereafter “first behavioral factor”) attributable to the first customer given a characteristic related to the first new transaction; augmenting the customer profile by storing therein the predictor, wherein the predictor: modifies at least one of the rules of the engagement rules and links the behavioral factor to the characteristic of the first transaction; detecting the characteristic as being present in an incoming one of the transactions (hereafter “incoming transaction”) involving a second one of the entities (hereafter “second entity”); and modifying, in accordance with the behavioral factor of the predictor, a manner in which the personal assistant conducts the incoming interaction with the second entity on behalf of the first customer.

These and other features of the present application will become more apparent upon review of the following detailed description of the example embodiments when taken in conjunction with the drawings and the appended claims.

### BRIEF DESCRIPTION OF THE DRAWINGS

A more complete appreciation of the present invention will become more readily apparent as the invention becomes better understood by reference to the following detailed description when considered in conjunction with the accompanying drawings, in which like reference symbols indicate like components, wherein:

FIG. 1 depicts a schematic block diagram of a computing device in accordance with exemplary embodiments of the present invention and/or with which exemplary embodiments of the present invention may be enabled or practiced;

FIG. 2 depicts a schematic block diagram of a communications infrastructure or contact center in accordance with exemplary embodiments of the present invention and/or with which exemplary embodiments of the present invention may be enabled or practiced;

FIG. 3 is schematic block diagram showing further details of a chat server operating as part of the chat system according to embodiments of the present invention;

FIG. 4 is a schematic block diagram of a chat module according to embodiments of the present invention;

FIG. 5 is an exemplary customer chat interface according to embodiments of the present invention;

FIG. 6 is a block diagram of a customer automation system according to embodiments of the present invention;

FIG. 7 is a flowchart of a method for automating an interaction on behalf of a customer according to embodiments of the present invention;

FIG. 8 is a block diagram of an automated personal bot for a customer according to embodiments of the present invention;

FIG. 9 is a schematic representation of an exemplary system including a personal bot and personalized customer profile in accordance with the present invention;

FIG. 10 is a schematic representation of an exemplary system including a personal data custodian in accordance with an exemplary embodiment of the present invention; and

FIG. 11 is a schematic representation of an exemplary system including a personal data custodian in accordance with an alternative embodiment of the present invention.

### DETAILED DESCRIPTION

For the purposes of promoting an understanding of the principles of the invention, reference will now be made to the exemplary embodiments illustrated in the drawings and specific language will be used to describe the same. It will be apparent, however, to one having ordinary skill in the art that the detailed material provided in the examples may not be needed to practice the present invention. In other instances, well-known materials or methods have not been described in detail in order to avoid obscuring the present invention. Additionally, further modification in the provided examples or application of the principles of the invention, as presented herein, are contemplated as would normally occur to those skilled in the art.

As used herein, language designating nonlimiting examples and illustrations includes “e.g.”, “i.e.”, “for example”, “for instance” and the like. Further, reference throughout this specification to “an embodiment”, “one embodiment”, “present embodiments”, “exemplary embodiments” and the like means that a particular feature or characteristic described in connection with the given example may be included in at least one embodiment of the present invention. Thus, appearances of the phrases “an embodiment”, “one embodiment”, “present embodiments”, “exemplary embodiments” and the like are not necessarily referring to the same embodiment or example. Further, particular features, structures or characteristics may be combined in any suitable combinations and/or sub-combinations in one or more embodiments or examples.

Those skilled in the art will recognize from the present disclosure that the various embodiments may be computer implemented using many different types of data processing equipment, with embodiments being implemented as an apparatus, method, or computer program product. Example embodiments, thus, may take the form of an entirely hardware embodiment, an entirely software embodiment, or an embodiment combining software and hardware aspects. Example embodiments further may take the form of a computer program product embodied by computer-usable program code in any tangible medium of expression. In each case, the example embodiment may be generally referred to as a “module”, “system”, or “method”.

The flowcharts and block diagrams provided in the figures illustrate architecture, functionality, and operation of possible implementations of systems, methods, and computer program products in accordance with example embodiments of the present invention. In this regard, it will be understood that each block of the flowcharts and/or block diagrams—or combinations of those blocks—may represent a module, segment, or portion of program code having one or more executable instructions for implementing the specified logical functions. It will similarly be understood that each of block of the flowcharts and/or block diagrams—or combinations of those blocks—may be implemented by special purpose hardware-based systems or combinations of special purpose hardware and computer instructions performing the specified acts or functions. Such computer program instructions also may be stored in a computer-readable medium that can direct a computer or other programmable data processing apparatus to function in a particular manner, such that the program instructions in the computer-readable medium produces an article of manufacture that includes instructions by which the functions or acts specified in each block of the flowcharts and/or block diagrams—or combinations of those blocks—are implemented.

### Computing Device

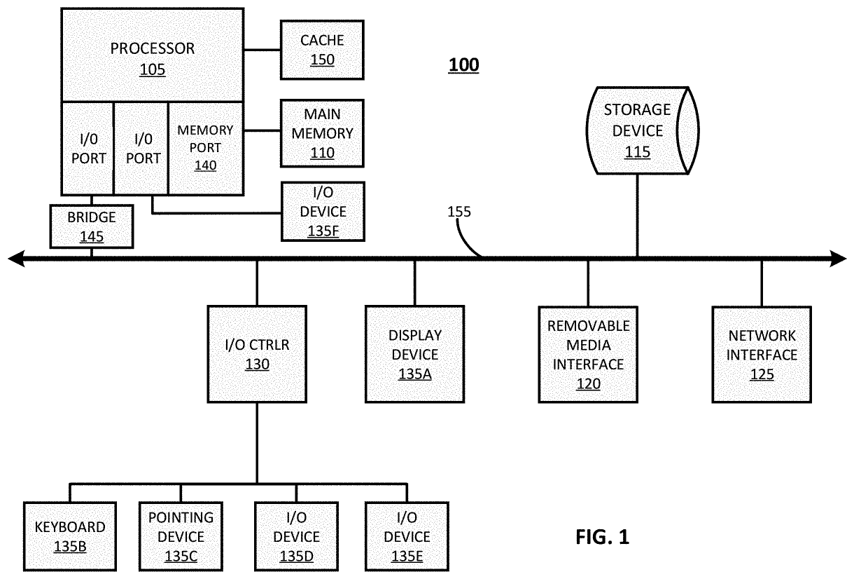

It will be appreciated that the systems and methods of the present invention may be computer implemented using many different forms of data processing equipment, for example, digital microprocessors and associated memory executing software programs. By way of background, FIG. 1 illustrates a schematic block diagram of an exemplary computing device 100 in accordance with embodiments of the present invention and/or with which those embodiments may be practiced. It should be understood that FIG. 1 is provided as a non-limiting example.

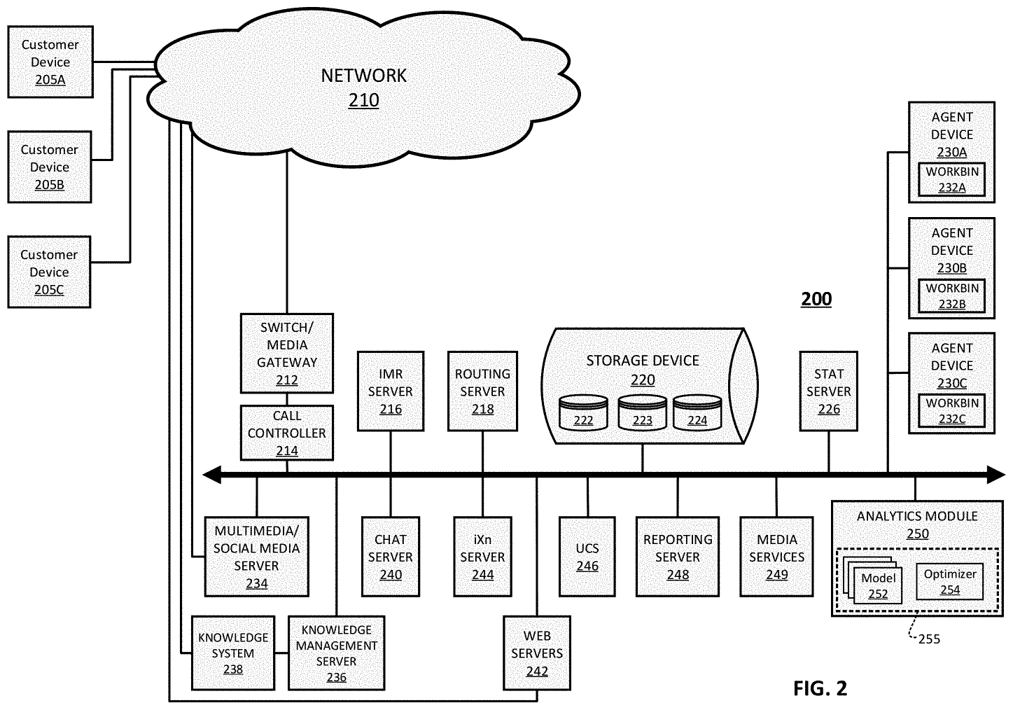

The computing device 100, for example, may be implemented via firmware (e.g., an application-specific integrated circuit), hardware, or a combination of software, firmware, and hardware. Each of the servers, controllers, switches, gateways, engines, and/or modules in the following figures (which collectively may be referred to as servers or modules) may be implemented via one or more of the computing devices 100. As an example, the various servers may be a process running on one or more processors of one or more computing devices 100, which may be executing computer program instructions and interacting with other systems or modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described in the following figures—such as, for example, the contact center system 200 of FIG. 2—the various servers and computer devices thereof may be located on local computing devices 100 (i.e., on-site or at the same physical location as contact center agents), remote computing devices 100 (i.e., off-site or in a cloud computing environment, for example, in a remote data center connected to the contact center via a network), or some combination thereof. Functionality provided by servers located on off-site computing devices may be accessed and provided over a virtual private network (VPN), as if such servers were on-site, or the functionality may be provided using a software as a service (SaaS) accessed over the Internet using various protocols, such as by exchanging data via extensible markup language (XML), JSON, and the like.

As shown in the illustrated example, the computing device 100 may include a central processing unit (CPU) or processor 105 and a main memory 110. The computing device 100 may also include a storage device 115, removable media interface 120, network interface 125, I/O controller 130, and one or more input/output (I/O) devices 135, which as depicted may include an, display device 135A, keyboard 135B, and pointing device 135C. The computing device 100 further may include additional elements, such as a memory port 140, a bridge 145, I/O ports, one or more additional input/output devices 135D, 135E, 135F, and a cache memory 150 in communication with the processor 105.

The processor 105 may be any logic circuitry that responds to and processes instructions fetched from the main memory 110. For example, the process 105 may be implemented by an integrated circuit, e.g., a microprocessor, microcontroller, or graphics processing unit, or in a field-programmable gate array or application-specific integrated circuit. As depicted, the processor 105 may communicate directly with the cache memory 150 via a secondary bus or backside bus. The cache memory 150 typically has a faster response time than main memory 110. The main memory 110 may be one or more memory chips capable of storing data and allowing stored data to be directly accessed by the central processing unit 105. The storage device 115 may provide storage for an operating system, which controls scheduling tasks and access to system resources, and other software. Unless otherwise limited, the computing device 100 may include an operating system and software capable of performing the functionality described herein.

As depicted in the illustrated example, the computing device 100 may include a wide variety of I/O devices 135, one or more of which may be connected via the I/O controller 130. Input devices, for example, may include a keyboard 135B and a pointing device 135C, e.g., a mouse or optical pen. Output devices, for example, may include video display devices, speakers, and printers. The I/O devices 135 and/or the I/O controller 130 may include suitable hardware and/or software for enabling the use of multiple display devices. The computing device 100 may also support one or more removable media interfaces 120, such as a disk drive, USB port, or any other device suitable for reading data from or writing data to computer readable media. More generally, the I/O devices 135 may include any conventional devices for performing the functionality described herein.

The computing device 100 may be any workstation, desktop computer, laptop or notebook computer, server machine, virtualized machine, mobile or smart phone, portable telecommunication device, media playing device, gaming system, mobile computing device, or any other type of computing, telecommunications or media device, without limitation, capable of performing the operations and functionality described herein. The computing device 100 may include a plurality of devices connected by a network or connected to other systems and resources via a network. As used herein, a network includes one or more computing devices, machines, clients, client nodes, client machines, client computers, client devices, endpoints, or endpoint nodes in communication with one or more other computing devices, machines, clients, client nodes, client machines, client computers, client devices, endpoints, or endpoint nodes. For example, the network may be a private or public switched telephone network (PSTN), wireless carrier network, local area network (LAN), private wide area network (WAN), public WAN such as the Internet, etc., with connections being established using appropriate communication protocols. More generally, it should be understood that, unless otherwise limited, the computing device 100 may communicate with other computing devices 100 via any type of network using any conventional communication protocol. Further, the network may be a virtual network environment where various network components are virtualized. For example, the various machines may be virtual machines implemented as a software-based computer running on a physical machine, or a “hypervisor” type of virtualization may be used where multiple virtual machines run on the same host physical machine. Other types of virtualization are also contemplated.

### Contact Center

With reference now to FIG. 2, a communications infrastructure or contact center system 200 is shown in accordance with exemplary embodiments of the present invention and/or with which exemplary embodiments of the present invention may be enabled or practiced. It should be understood that the term “contact center system” is used herein to refer to the system depicted in FIG. 2 and/or the components thereof, while the term “contact center” is used more generally to refer to contact center systems, customer service providers operating those systems, and/or the organizations or enterprises associated therewith. Thus, unless otherwise specifically limited, the term “contact center” refers generally to a contact center system (such as the contact center system 200), the associated customer service provider (such as a particular customer service provider providing customer services through the contact center system 200), as well as the organization or enterprise on behalf of which those customer services are being provided.

By way of background, customer service providers generally offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals” or “customers”). For example, the agents at a contact center may assist customers in making purchasing decisions, receiving orders, or solving problems with products or services already received. Within a contact center, such interactions between contact center agents and outside entities or customers may be conducted over a variety of communication channels, such as, for example, via voice (e.g., telephone calls or voice over IP or VoIP calls), video (e.g., video conferencing), text (e.g., emails and text chat), screen sharing, co-browsing, or the like.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize some level of automated processes in place of live agents, such as, for example, interactive voice response (IVR) systems, interactive media response (IMR) systems, internet robots or “bots”, automated chat modules or “chatbots”, and the like. In many cases this has proven to be a successful strategy, as automated processes can be highly efficient in handling certain types of interactions and effective at decreasing the need for live agents. Such automation allows contact centers to target the use of human agents for the more difficult customer interactions, while the automated processes handle the more repetitive or routine tasks. Further, automated processes can be structured in a way that optimizes efficiency and promotes repeatability. Whereas a human or live agent may forget to ask certain questions or follow-up on particular details, such mistakes are typically avoided through the use of automated processes. While customer service providers are increasingly relying on automated processes to interact with customers, the use of such technologies by customers remains far less developed. Thus, while IVR systems, IMR systems, and/or bots are used to automate portions of the interaction on the contact center-side of an interaction, the actions on the customer-side remain for the customer to perform manually.

Referring specifically to FIG. 2, the contact center system 200 may be used by a customer service provider to provide various types of services to customers. For example, the contact center system 200 may be used to engage and manage interactions in which automated processes (or bots) or human agents communicate with customers. As should be understood, the contact center system 200 may be an in-house facility to a business or enterprise for performing the functions of sales and customer service relative to products and services available through the enterprise. In another aspect, the contact center system 200 may be operated by a third-party service provider that contracts to provide services for another organization. Further, the contact center system 200 may be deployed on equipment dedicated to the enterprise or third-party service provider, and/or deployed in a remote computing environment such as, for example, a private or public cloud environment with infrastructure for supporting multiple contact centers for multiple enterprises. The contact center system 200 may include software applications or programs, which may be executed on premises or remotely or some combination thereof. It should further be appreciated that the various components of the contact center system 200 may be distributed across various geographic locations and not necessarily contained in a single location or computing environment.

It should further be understood that, unless otherwise specifically limited, any of the computing elements of the present invention may be implemented in cloud-based or cloud computing environments. As used herein, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture”, a cloud execution model generally includes a service provider dynamically managing an allocation and provisioning of remote servers for achieving a desired functionality.

In accordance with the illustrated example of FIG. 2, the components or modules of the contact center system 200 may include: a plurality of customer devices 205A, 205B, 205C; communications network (or simply “network”) 210; switch/media gateway 212; call controller 214; interactive media response (IMR) server 216; routing server 218; storage device 220; statistics (or “stat”) server 226; plurality of agent devices 230A, 230B, 230C that include workbins 232A, 232B, 232C, respectively; multimedia/social media server 234; knowledge management server 236 coupled to a knowledge system 238; chat server 240; web servers 242; interaction (or “iXn”) server 244; universal contact server (or “UCS”) 246; reporting server 248; media services server 249; and analytics module 250. It should be understood that any of the computer-implemented components, modules, or servers described in relation to FIG. 2 or in any of the following figures may be implemented via types of computing devices, such as, for example, the computing device 100 of FIG. 1. As will be seen, the contact center system 200 generally manages resources (e.g., personnel, computers, telecommunication equipment, etc.) to enable delivery of services via telephone, email, chat, or other communication mechanisms. Such services may vary depending on the type of contact center and, for example, may include customer service, help desk functionality, emergency response, telemarketing, order taking, and the like.

Customers desiring to receive services from the contact center system 200 may initiate inbound communications (e.g., telephone calls, emails, chats, etc.) to the contact center system 200 via a customer device 205. While FIG. 2 shows three such customer devices—i.e., customer devices 205A, 205B, and 205C—it should be understood that any number may be present. The customer devices 205, for example, may be a communication device, such as a telephone, smart phone, computer, tablet, or laptop. In accordance with functionality described herein, customers may generally use the customer devices 205 to initiate, manage, and conduct communications with the contact center system 200, such as telephone calls, emails, chats, text messages, web-browsing sessions, and other multi-media transactions.

Inbound and outbound communications from and to the customer devices 205 may traverse the network 210, with the nature of network typically depending on the type of customer device being used and form of communication. As an example, the network 210 may include a communication network of telephone, cellular, and/or data services. The network 210 may be a private or public switched telephone network (PSTN), local area network (LAN), private wide area network (WAN), and/or public WAN such as the Internet. Further, the network 210 may include a wireless carrier network including a code division multiple access (CDMA) network, global system for mobile communications (GSM) network, or any wireless network/technology conventional in the art, including but not limited to 3G, 4G, LTE, 5G, etc.

In regard to the switch/media gateway 212, it may be coupled to the network 210 for receiving and transmitting telephone calls between customers and the contact center system 200. The switch/media gateway 212 may include a telephone or communication switch configured to function as a central switch for agent level routing within the center. The switch may be a hardware switching system or implemented via software. For example, the switch 215 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 230. Thus, in general, the switch/media gateway 212 establishes a voice connection between the customer and the agent by establishing a connection between the customer device 205 and agent device 230.

As further shown, the switch/media gateway 212 may be coupled to the call controller 214 which, for example, serves as an adapter or interface between the switch and the other routing, monitoring, and communication-handling components of the contact center system 200. The call controller 214 may be configured to process PSTN calls, VoIP calls, etc. For example, the call controller 214 may include computer-telephone integration (CTI) software for interfacing with the switch/media gateway and other components. The call controller 214 may include a session initiation protocol (SIP) server for processing SIP calls. The call controller 214 may also extract data about an incoming interaction, such as the customer's telephone number, IP address, or email address, and then communicate these with other contact center components in processing the interaction.

In regard to the interactive media response (IMR) server 216, it may be configured to enable self-help or virtual assistant functionality. Specifically, the IMR server 216 may be similar to an interactive voice response (IVR) server, except that the IMR server 216 is not restricted to voice and may also cover a variety of media channels. In an example illustrating voice, the IMR server 216 may be configured with an IMR script for querying customers on their needs. For example, a contact center for a bank may tell customers via the IMR script to “press 1” if they wish to retrieve their account balance. Through continued interaction with the IMR server 216, customers may receive service without needing to speak with an agent. The IMR server 216 may also be configured to ascertain why a customer is contacting the contact center so that the communication may be routed to the appropriate resource.

In regard to the routing server 218, it may function to route incoming interactions. For example, once it is determined that an inbound communication should be handled by a human agent, functionality within the routing server 218 may select the most appropriate agent and route the communication thereto. This agent selection may be based on which available agent is best suited for handling the communication. More specifically, the selection of appropriate agent may be based on a routing strategy or algorithm that is implemented by the routing server 218. In doing this, the routing server 218 may query data that is relevant to the incoming interaction, for example, data relating to the particular customer, available agents, and the type of interaction, which, as described more below, may be stored in particular databases. Once the agent is selected, the routing server 218 may interact with the call controller 214 to route (i.e., connect) the incoming interaction to the corresponding agent device 230. As part of this connection, information about the customer may be provided to the selected agent via their agent device 230. This information is intended to enhance the service the agent is able to provide to the customer.

Regarding data storage, the contact center system 200 may include one or more mass storage devices—represented generally by the storage device 220—for storing data in one or more databases relevant to the functioning of the contact center. For example, the storage device 220 may store customer data that is maintained in a customer database 222. Such customer data may include customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 220 may store agent data in an agent database 223. Agent data maintained by the contact center system 200 may include agent availability and agent profiles, schedules, skills, handle time, etc. As another example, the storage device 220 may store interaction data in an interaction database 224. Interaction data may include data relating to numerous past interactions between customers and contact centers. More generally, it should be understood that, unless otherwise specified, the storage device 220 may be configured to include databases and/or store data related to any of the types of information described herein, with those databases and/or data being accessible to the other modules or servers of the contact center system 200 in ways that facilitate the functionality described herein. For example, the servers or modules of the contact center system 200 may query such databases to retrieve data stored therewithin or transmit data thereto for storage. The storage device 220, for example, may take the form of any conventional storage medium and may be locally housed or operated from a remote location. As an example, the databases may be Cassandra database, NoSQL database, or a SQL database and managed by a database management system, such as, Oracle, IBM DB2, Microsoft SQL server, or Microsoft Access, PostgreSQL.

In regard to the stat server 226, it may be configured to record and aggregate data relating to the performance and operational aspects of the contact center system 200. Such information may be compiled by the stat server 226 and made available to other servers and modules, such as the reporting server 248, which then may use the data to produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 230 of the contact center 200 may be communication devices configured to interact with the various components and modules of the contact center system 200 in ways that facilitate functionality described herein. An agent device 230, for example, may include a telephone adapted for regular telephone calls or VoIP calls. An agent device 230 may further include a computing device configured to communicate with the servers of the contact center system 200, perform data processing associated with operations, and interface with customers via voice, chat, email, and other multimedia communication mechanisms according to functionality described herein. While FIG. 2 shows three such agent devices—i.e., agent devices 230A, 230B and 230C—it should be understood that any number may be present.

In regard to the multimedia/social media server 234, it may be configured to facilitate media interactions (other than voice) with the customer devices 205 and/or the servers 242. Such media interactions may be related, for example, to email, voice mail, chat, video, text-messaging, web, social media, co-browsing, etc. The multi-media/social media server 234 may take the form of any IP router conventional in the art with specialized hardware and software for receiving, processing, and forwarding multi-media events and communications.

In regard to the knowledge management server 234, it may be configured facilitate interactions between customers and the knowledge system 238. In general, the knowledge system 238 may be a computer system capable of receiving questions or queries and providing answers in response. The knowledge system 238 may be included as part of the contact center system 200 or operated remotely by a third party. The knowledge system 238 may include an artificially intelligent computer system capable of answering questions posed in natural language by retrieving information from information sources such as encyclopedias, dictionaries, newswire articles, literary works, or other documents submitted to the knowledge system 238 as reference materials, as is known in the art. As an example, the knowledge system 238 may be embodied as IBM Watson or a like system.

In regard to the chat server 240, it may be configured to conduct, orchestrate, and manage electronic chat communications with customers. In general, the chat server 240 is configured to implement and maintain chat conversations and generate chat transcripts. Such chat communications may be conducted by the chat server 240 in such a way that a customer communicates with automated chatbots, human agents, or both. In exemplary embodiments, the chat server 240 may perform as a chat orchestration server that dispatches chat conversations among the chatbots and available human agents. In such cases, the processing logic of the chat server 240 may be rules driven so to leverage an intelligent workload distribution among available chat resources. The chat server 240 further may implement, manage and facilitate user interfaces (also UIs) associated with the chat feature, including those UIs generated at either the customer device 205 or the agent device 230. The chat server 240 may be configured to transfer chats within a single chat session with a particular customer between automated and human sources such that, for example, a chat session transfers from a chatbot to a human agent or from a human agent to a chatbot. The chat server 240 may also be coupled to the knowledge management server 234 and the knowledge systems 238 for receiving suggestions and answers to queries posed by customers during a chat so that, for example, links to relevant articles can be provided.

In regard to the web servers 242, such servers may be included to provide site hosts for a variety of social interaction sites to which customers subscribe, such as Facebook, Twitter, Instagram, etc. Though depicted as part of the contact center system 200, it should be understood that the web servers 242 may be provided by third parties and/or maintained remotely. The web servers 242 may also provide webpages for the enterprise or organization being supported by the contact center system 200. For example, customers may browse the webpages and receive information about the products and services of a particular enterprise. Within such enterprise webpages, mechanisms may be provided for initiating an interaction with the contact center system 200, for example, via web chat, voice, or email. An example of such a mechanism is a widget, which can be deployed on the webpages or websites hosted on the web servers 242. As used herein, a widget refers to a user interface component that performs a particular function. In some implementations, a widget may include a graphical user interface control that can be overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Some widgets can include corresponding or additional user interfaces and be configured to access a variety of local resources (e.g., a calendar or contact information on the customer device) or remote resources via network (e.g., instant messaging, electronic mail, or social networking updates).

In regard to the interaction (iXn) server 244, it may be configured to manage deferrable activities of the contact center and the routing thereof to human agents for completion. As used herein, deferrable activities include back-office work that can be performed off-line, e.g., responding to emails, attending training, and other activities that do not entail real-time communication with a customer. As an example, the interaction (iXn) server 244 may be configured to interact with the routing server 218 for selecting an appropriate agent to handle each of the deferable activities. Once assigned to a particular agent, the deferable activity is pushed to that agent so that it appears on the agent device 230 of the selected agent. The deferable activity may appear in a workbin 232 as a task for the selected agent to complete. The functionality of the workbin 232 may be implemented via any conventional data structure, such as, for example, a linked list, array, etc. Each of the agent devices 230 may include a workbin 232, with the workbins 232A, 232B, and 232C being maintained in the agent devices 230A, 230B, and 230C, respectively. As an example, a workbin 232 may be maintained in the buffer memory of the corresponding agent device 230.

In regard to the universal contact server (UCS) 246, it may be configured to retrieve information stored in the customer database 222 and/or transmit information thereto for storage therein. For example, the UCS 246 may be utilized as part of the chat feature to facilitate maintaining a history on how chats with a particular customer were handled, which then may be used as a reference for how future chats should be handled. More generally, the UCS 246 may be configured to facilitate maintaining a history of customer preferences, such as preferred media channels and best times to contact. To do this, the UCS 246 may be configured to identify data pertinent to the interaction history for each customer such as, for example, data related to comments from agents, customer communication history, and the like. Each of these data types then may be stored in the customer database 222 or on other modules and retrieved as functionality described herein requires.

In regard to the reporting server 248, it may be configured to generate reports from data compiled and aggregated by the statistics server 226 or other sources. Such reports may include near real-time reports or historical reports and concern the state of contact center resources and performance characteristics, such as, for example, average wait time, abandonment rate, agent occupancy. The reports may be generated automatically or in response to specific requests from a requestor (e.g., agent, administrator, contact center application, etc.). The reports then may be used toward managing the contact center operations in accordance with functionality described herein.

In regard to the media services server 249, it may be configured to provide audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, keyword spotting, and the like.

In regard to the analytics module 250, it may be configured to provide systems for performing analytics on data received from a plurality of different data sources as functionality described herein may require. In accordance with example embodiments, the analytics module 250 also may generate, update, train, and modify predictors or models 252 based on collected data, such as, for example, customer data, agent data, and interaction data. The models 252 may include behavior models of customers or agents. The behavior models may be used to predict behaviors of, for example, customers or agents, in a variety of situations, thereby allowing embodiments of the present invention to tailor interactions based on such predictions or to allocate resources in preparation for predicted characteristics of future interactions, thereby improving overall contact center performance and the customer experience. It will be appreciated that, while the analytics module 250 is depicted as being part of a contact center, such behavior models also may be implemented on customer systems (or, as also used herein, on the “customer-side” of the interaction) and used for the benefit of customers.

According to exemplary embodiments, the analytics module 250 may have access to the data stored in the storage device 220, including the customer database 222 and agent database 223. The analytics module 250 also may have access to the interaction database 224, which stores data related to interactions and interaction content (e.g., transcripts of the interactions and events detected therein), interaction metadata (e.g., customer identifier, agent identifier, medium of interaction, length of interaction, interaction start and end time, department, tagged categories), and the application setting (e.g., the interaction path through the contact center). Further, as discussed more below, the analytic module 250 may be configured to retrieve data stored within the storage device 220 for use in developing and training algorithms and models 252, for example, by applying machine learning techniques.

One or more of the included models 252 may be configured to predict customer or agent behavior and/or aspects related to contact center operation and performance. Further, one or more of the models 252 may be used in natural language processing and, for example, include intent recognition and the like. The models 252 may be developed based upon 1) known first principle equations describing a system, 2) data, resulting in an empirical model, or 3) a combination of known first principle equations and data. In developing a model for use with present embodiments, because first principles equations are often not available or easily derived, it may be generally preferred to build an empirical model based upon collected and stored data. To properly capture the relationship between the manipulated/disturbance variables and the controlled variables of complex systems, it may be preferable that the models 252 are nonlinear. This is because nonlinear models can represent curved rather than straight-line relationships between manipulated/disturbance variables and controlled variables, which are common to complex systems such as those discussed herein. Given the foregoing requirements, a machine learning or neural network-based approach is presently a preferred embodiment for implementing the models 252. Neural networks, for example, may be developed based upon empirical data using advanced regression algorithms.

The analytics module 250 may further include an optimizer 254. As will be appreciated, an optimizer may be used to minimize a “cost function” subject to a set of constraints, where the cost function is a mathematical representation of desired objectives or system operation. Because the models 252 may be non-linear, the optimizer 254 may be a nonlinear programming optimizer. It is contemplated, however, that the present invention may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like.

According to exemplary embodiments, the models 252 and the optimizer 254 may together be used within an optimization system 255. For example, the analytics module 250 may utilize the optimization system 255 as part of an optimization process by which aspects of contact center performance and operation are optimized or, at least, enhanced. This, for example, may include aspects related to the customer experience, agent experience, interaction routing, natural language processing, intent recognition, or other functionality related to automated processes.

The various components, modules, and/or servers of FIG. 2 (as well as the other figures included herein) may each include one or more processors executing computer program instructions and interacting with other system components for performing the various functionalities described herein. Such computer program instructions may be stored in a memory implemented using a standard memory device, such as, for example, a random-access memory (RAM), or stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers without departing from the scope of the present invention. Further, the terms “interaction” and “communication” are used interchangeably, and generally refer to any real-time and non-real-time interaction that uses any communication channel including, without limitation, telephone calls (PSTN or VoIP calls), emails, vmails, video, chat, screen-sharing, text messages, social media messages, WebRTC calls, etc. Access to and control of the components of the contact system 200 may be affected through user interfaces (UIs) which may be generated on the customer devices 205 and/or the agent devices 230. As already noted, the contact center system 200 may operate as a hybrid system in which some or all components are hosted remotely, such as in a cloud-based or cloud computing environment.

### Chat Systems

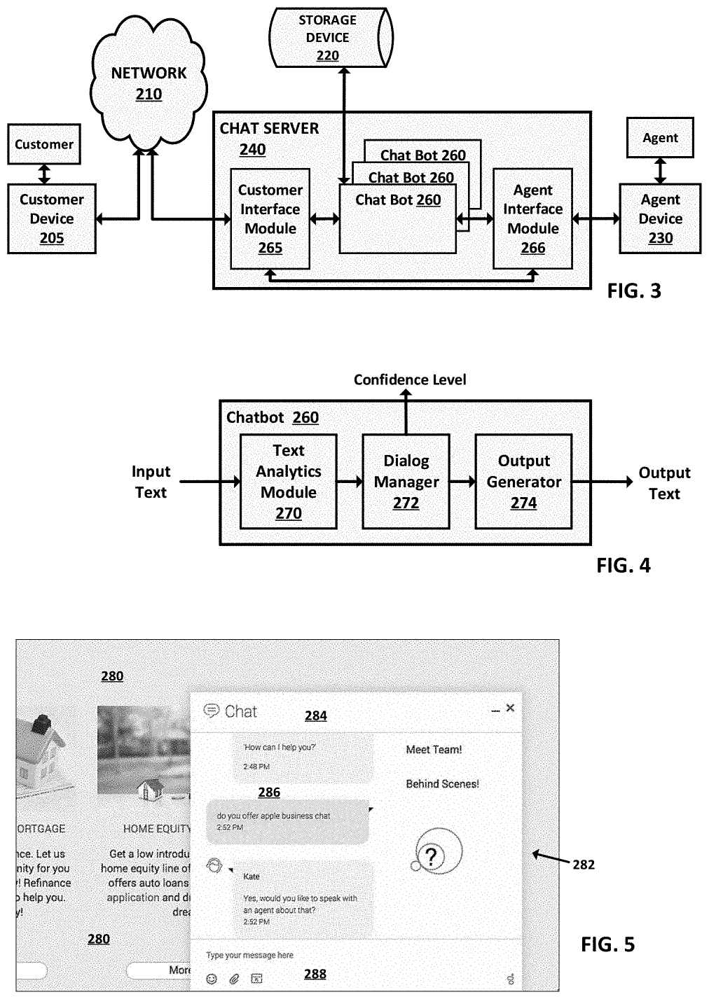

Turning to FIGS. 3, 4 and 5, various aspects of chat systems and chatbots are shown. As will be seen, present embodiments may include or be enabled by such chat features, which, in general, enable the exchange of text messages between different parties. Those parties may include live persons, such as customers and agents, as well as automated processes, such as bots or chatbots.

By way of background, a bot (also known as an “Internet bot”) is a software application that runs automated tasks or scripts over the Internet. Typically, bots perform tasks that are both simple and structurally repetitive at a much higher rate than would be possible for a person. A chatbot is a particular type of bot and, as used herein, is defined as a piece of software and/or hardware that conducts a conversation via auditory or textual methods. As will be appreciated, chatbots are often designed to convincingly simulate how a human would behave as a conversational partner. Chatbots are typically used in dialog systems for various practical purposes including customer service or information acquisition. Some chatbots use sophisticated natural language processing systems, while simpler chatbots scan for keywords within the input and then select a reply from a database based on matching keywords or wording pattern.

Before proceeding further with the description of the present invention, an explanatory note will be provided in regard to referencing system components—e.g., modules, servers, and other components—that have already been introduced in any previous figure. Whether or not the subsequent reference includes the corresponding numerical identifiers used in the previous figures, it should be understood that the reference incorporates the example described in the previous figures and, unless otherwise specifically limited, may be implemented in accordance with either that examples or other conventional technology capable of fulfilling the desired functionality, as would be understood by one of ordinary skill in the art. Thus, for example, subsequent mention of a “contact center system” should be understood as referring to the exemplary “contact center system 200” of FIG. 2 and/or other conventional technologies for implementing a contact center system. As additional examples, a subsequent mention below to a “customer device”, “agent device”, “chat server”, or “computing device” should be understood as referring to the exemplary “customer device 205”, “agent device 230”, “chat server 240”, or “computing device 200”, respectively, of FIGS. 1-2, as well as conventional technology for fulfilling the same functionality.

Chat features and chatbots will now be discussed in greater specificity with reference to the exemplary embodiments of a chat server, chatbot, and chat interface depicted, respectively, in FIGS. 3, 4, and 5. While these examples are provided with respect to chat systems implemented on the contact center-side, such chat systems may be used on the customer-side of an interaction. Thus, it should be understood that the exemplary chat systems of FIGS. 3, 4, and 5 may be modified for analogous customer-side implementation, including the use of customer-side chatbots configured to interact with agents and chatbots of contact centers on a customer's behalf. It should further be understood that chat features may be utilized by voice communications via converting text-to-speech and/or speech-to-text.

Referring specifically now to FIG. 3, a more detailed block diagram is provided of a chat server 240, which may be used to implement chat systems and features. The chat server 240 may be coupled to (i.e., in electronic communication with) a customer device 205 operated by the customer over a data communications network 210. The chat server 240, for example, may be operated by a enterprise as part of a contact center for implementing and orchestrating chat conversations with the customers, including both automated chats and chats with human agents. In regard to automated chats, the chat server 240 may host chat automation modules or chatbots 260A-260C (collectively referenced as 260), which are configured with computer program instructions for engaging in chat conversations. Thus, generally, the chat server 240 implements chat functionality, including the exchange of text-based or chat communications between a customer device 205 and an agent device 230 or a chatbot 260. As discussed more below, the chat server 240 may include a customer interface module 265 and agent interface module 266 for generating particular UIs at the customer device 205 and the agent device 230, respectively, that facilitate chat functionality.

In regard to the chatbots 260, each can operate as an executable program that is launched according to demand. For example, the chat server 240 may operate as an execution engine for the chatbots 260, analogous to loading Voice)ML files to a media server for interactive voice response (IVR) functionality. Loading and unloading may be controlled by the chat server 240, analogous to how a VoiceXML script may be controlled in the context of an interactive voice response. The chat server 240 may further provide a means for capturing and collecting customer data in a unified way, similar to customer data capturing in the context of IVR. Such data can be stored, shared, and utilized in a subsequent conversation, whether with the same chatbot, a different chatbot, an agent chat, or even a different media type. In example embodiments, the chat server 240 is configured to orchestrate the sharing of data among the various chatbots 260 as interactions are transferred or transitioned over from one chatbot to another or from one chatbot to a human agent. The data captured during interaction with a particular chatbot may be transferred along with a request to invoke a second chatbot or human agent.

In exemplary embodiments, the number of chatbots 260 may vary according to the design and function of the chat server 240 and is not limited to the number illustrated in FIG. 3. Further, different chatbots may be created to have different profiles, which can then be selected between to match the subject matter of a particular chat or a particular customer. For example, the profile of a particular chatbot may include expertise for helping a customer on a particular subject or communication style aimed at a certain customer preference. More specifically, one chatbot may be designed to engage in a first topic of communication (e.g., opening a new account with the business), while another chatbot may be designed to engage in a second topic of communication (e.g., technical support for a product or service provided by the business). Or, chatbots may be configured to utilize different dialects or slang or have different personality traits or characteristics. Engaging chatbots with profiles that are catered to specific types of customers may enable more effective communication and results. The chatbot profiles may be selected based on information known about the other party, such as demographic information, interaction history, or data available on social media. The chat server 240 may host a default chatbot that is invoked if there is insufficient information about the customer to invoke a more specialized chatbot. Optionally, the different chatbots may be customer selectable. In exemplary embodiments, profiles of chatbots 260 may be stored in a profile database hosted in the storage device 220. Such profiles may include the chatbot' s personality, demographics, areas of expertise, and the like.

The customer interface module 265 and agent interface module 266 may be configured to generating user interfaces (UIs) for display on the customer device 205 that facilitate chat communications between the customer and a chatbot 260 or human agent. Likewise, an agent interface module 266 may generate particular UIs on the agent device 230 that facilitate chat communications between an agent operating an agent device 230 and the customer. The agent interface module 266 may also generate UIs on an agent device 230 that allow an agent to monitor aspects of an ongoing chat between a chatbot 260 and a customer. For example, the customer interface module 265 may transmit signals to the customer device 205 during a chat session that are configured to generated particular UIs on the customer device 205, which may include the display of the text messages being sent from the chatbot 260 or human agent as well as other non-text graphics that are intended to accompany the text messages, such as emoticons or animations. Similarly, the agent interface module 266 may transmit signals to the agent device 230 during a chat session that are configured to generated UIs on the agent device 230. Such UIs may include an interface that facilitates the agent selection of non-text graphics for accompanying outgoing text messages to customers.

In exemplary embodiments, the chat server 240 may be implemented in a layered architecture, with a media layer, a media control layer, and the chatbots executed by way of the IMR server 216 (similar to executing a VoiceXIVIL on an IVR media server). As described above, the chat server 240 may be configured to interact with the knowledge management server 234 to query the server for knowledge information. The query, for example, may be based on a question received from the customer during a chat. Responses received from the knowledge management server 234 may then be provided to the customer as part of a chat response.

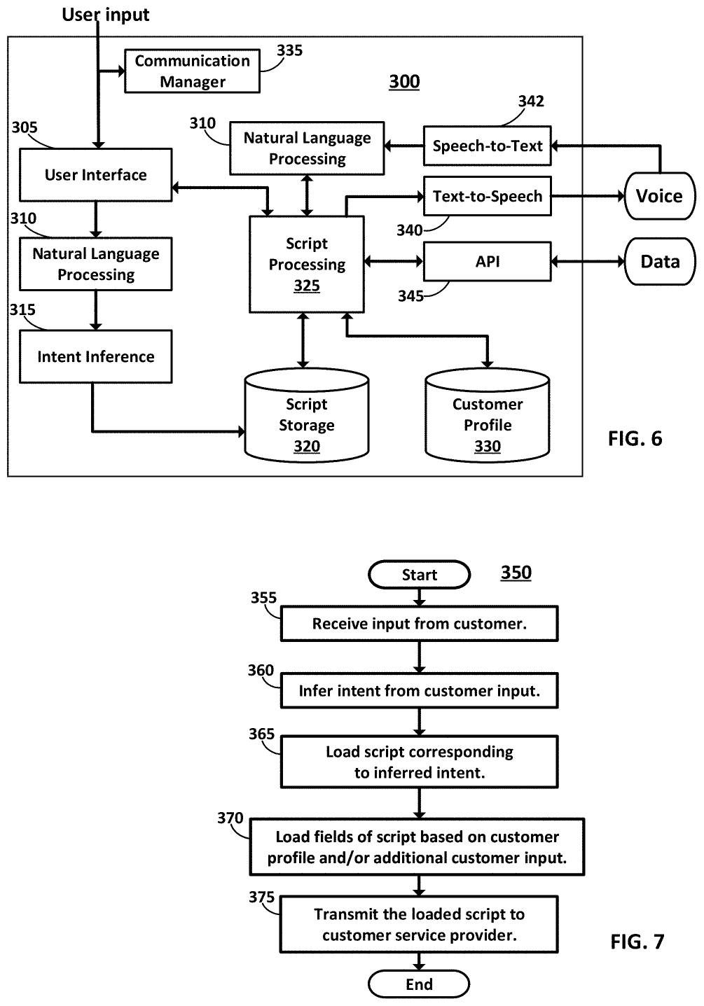

Referring specifically now to FIG. 4, a block diagram is provided of an exemplary chat automation module or chatbot 260. As illustrated, the chatbot 260 may include several modules, including a text analytics module 270, dialog manager 272, and output generator 274. It will be appreciated that, in a more detailed discussion of chatbot operability, other subsystems or modules may be described, including, for examples, modules related to intent recognition, text-to-speech or speech-to-text modules, as well as modules related to script storage, retrieval, and data field processing in accordance with information stored in agent or customer profiles. Such topics, however, are covered more completely in other areas of this disclosure—for example, in relation to FIGS. 6 and 7—and so will not be repeated here. It should nevertheless be understood that the disclosures made in these areas may be used in analogous ways toward chatbot operability in accordance with functionality described herein.

The text analytics module 270 may be configured to analyze and understand natural language. In this regard, the text analytics module may be configured with a lexicon of the language, syntactic/semantic parser, and grammar rules for breaking a phrase provided by the customer device 205 into an internal syntactic and semantic representation. The configuration of the text analytics module depends on the particular profile associated with the chatbot. For example, certain words may be included in the lexicon for one chatbot but excluded that of another.

The dialog manager 272 receives the syntactic and semantic representation from the text analytics module 270 and manages the general flow of the conversation based on a set of decision rules. In this regard, the dialog manager 272 maintains a history and state of the conversation and, based on those, generates an outbound communication. The communication may follow the script of a particular conversation path selected by the dialog manager 272. As described in further detail below, the conversation path may be selected based on an understanding of a particular purpose or topic of the conversation. The script for the conversation path may be generated using any of various languages and frameworks conventional in the art, such as, for example, artificial intelligence markup language (AIML), SCXML, or the like.

During the chat conversation, the dialog manager 272 selects a response deemed to be appropriate at the particular point of the conversation flow/script and outputs the response to the output generator 274. In exemplary embodiments, the dialog manager 272 may also be configured to compute a confidence level for the selected response and provide the confidence level to the agent device 230. Every segment, step, or input in a chat communication may have a corresponding list of possible responses. Responses may be categorized based on topics (determined using a suitable text analytics and topic detection scheme) and suggested next actions are assigned. Actions may include, for example, responses with answers, additional questions, transfer to a human agent to assist, and the like. The confidence level may be utilized to assist the system with deciding whether the detection, analysis, and response to the customer input is appropriate or whether a human agent should be involved. For example, a threshold confidence level may be assigned to invoke human agent intervention based on one or more business rules. In exemplary embodiments, confidence level may be determined based on customer feedback. As described, the response selected by the dialog manager 272 may include information provided by the knowledge management server 234.

In exemplary embodiments, the output generator 274 takes the semantic representation of the response provided by the dialog manager 272, maps the response to a chatbot profile or personality (e.g., by adjusting the language of the response according to the dialect, vocabulary, or personality of the chatbot), and outputs an output text to be displayed at the customer device 205. The output text may be intentionally presented such that the customer interacting with a chatbot is unaware that it is interacting with an automated process as opposed to a human agent. As will be seen, in accordance with other embodiments, the output text may be linked with visual representations, such as emoticons or animations, integrated into the customer's user interface.

Reference will now be made to FIG. 5, in which a webpage 280 having an exemplary implementation of a chat feature 282 is presented. The webpage 280, for example, may be associated with a enterprise website and intended to initiate interaction between prospective or current customers visiting the webpage and a contact center associated with the enterprise. As will be appreciated, the chat feature 282 may be generated on any type of customer device 205, including personal computing devices such as laptops, tablet devices, or smart phones. Further, the chat feature 282 may be generated as a window within a webpage or implemented as a full-screen interface. As in the example shown, the chat feature 282 may be contained within a defined portion of the webpage 280 and, for example, may be implemented as a widget via the systems and components described above and/or any other conventional means. In general, the chat feature 282 may include an exemplary way for customers to enter text messages for delivery to a contact center.

As an example, the webpage 280 may be accessed by a customer via a customer device, such as the customer device, which provides a communication channel for chatting with chatbots or live agents. In exemplary embodiments, as shown, the chat feature 282 includes generating a user interface, which is referred to herein as a customer chat interface 284, on a display of the customer device. The customer chat interface 284, for example, may be generated by the customer interface module of a chat server, such as the chat server, as already described. As described, the customer interface module 265 may send signals to the customer device 205 that are configured to generate the desired customer chat interface 284, for example, in accordance with the content of a chat message issued by a chat source, which, in the example, is a chatbot or agent named “Kate”. The customer chat interface 284 may be contained within a designated area or window, with that window covering a designated portion of the webpage 280. The customer chat interface 284 also may include a text display area 286, which is the area dedicated to the chronological display of received and sent text messages. The customer chat interface 284 further includes a text input area 288, which is the designated area in which the customer inputs the text of their next message. As will be appreciated, other configurations are also possible.

### Customer Automation Systems

Embodiments of the present invention include systems and methods for automating and augmenting customer actions during various stages of interaction with a customer service provider or contact center. As will be seen, those various stages of interaction may be classified as pre-contact, during-contact, and post-contact stages (or, respectively, pre-interaction, during-interaction, and post-interaction stages). With specific reference now to FIG. 6, an exemplary customer automation system 300 is shown that may be used with embodiments of the present invention. To better explain how the customer automation system 300 functions, reference will also be made to FIG. 7, which provides a flowchart 350 of an exemplary method for automating customer actions when, for example, the customer interacts with a contact center. Additional information related to customer automation are provided in U.S. application Ser. No. 16/151,362, filed on Oct. 4, 2018, entitled “System and Method for Customer Experience Automation”, the entire content of which is incorporated herein by reference.

The customer automation system 300 of FIG. 6 represents a system that may be generally used for customer-side automations, which, as used herein, refers to the automation of actions taken on behalf of a customer in interactions with customer service providers or contact centers. Such interactions may also be referred to as “customer-contact center interactions” or simply “customer interactions”. Further, in discussing such customer-contact center interactions, it should be appreciated that reference to a “contact center” or “customer service provider” is intended to generally refer to any customer service department or other service provider associated with an organization or enterprise (such as, for example, a business, governmental agency, non-profit, school, etc.) with which a user or customer has business, transactions, affairs or other interests.

In exemplary embodiments, the customer automation system 300 may be implemented as a software program or application running on a mobile device or other computing device, cloud computing devices (e.g., computer servers connected to the customer device 205 over a network), or combinations thereof (e.g., some modules of the system are implemented in the local application while other modules are implemented in the cloud. For the sake of convenience, embodiments are primarily described in the context of implementation via an application running on the customer device 205. However, it should be understood that present embodiments are not limited thereto.

The customer automation system 300 may include several components or modules. In the illustrated example of FIG. 6, the customer automation system 300 includes a user interface 305, natural language processing (NLP) module 310, intent inference module 315, script storage module 320, script processing module 325, customer profile database or module (or simply “customer profile”) 330, communication manager module 335, text-to-speech module 340, speech-to-text module 342, and application programming interface (API) 345, each of which will be described with more particularity with reference also to flowchart 350 of FIG. 7. It will be appreciated that some of the components of and functionalities associated with the customer automations system 300 may overlap with the chatbot systems described above in relation to FIGS. 3, 4, and 5. In cases where the customer automation system 300 and such chatbot systems are employed together as part of a customer-side implementation, such overlap may include the sharing of resources between the two systems.

In an example of operation, with specific reference now to the flowchart 350 of FIG. 7, the customer automation system 300 may receive input at an initial step or operation 355. Such input may come from several sources. For example, a primary source of input may be the customer, where such input is received via the customer device. The input also may include data received from other parties, particularly parties interacting with the customer through the customer device. For example, information or communications sent to the customer from the contact center may provide aspects of the input. In either case, the input may be provided in the form of free speech or text (e.g., unstructured, natural language input). Input also may include other forms of data received or stored on the customer device.

Continuing with the flow diagram 350, at an operation 360, the customer automation system 300 parses the natural language of the input using the NLP module 310 and, therefrom, infers a intent using the intent inference module 315. For example, where the input is provided as speech from the customer, the speech may be transcribed into text by a speech-to-text system (such as a large vocabulary continuous speech recognition or LVCSR system) as part of the parsing by the NLP module 310. The transcription may be performed locally on the customer device 205 or the speech may be transmitted over a network for conversion to text by a cloud-based server. In certain embodiments, for example, the intent inference module 315 may automatically infer the customer's intent from the text of the provided input using artificial intelligence or machine learning techniques. Such artificial intelligence techniques may include, for example, identifying one or more keywords from the customer input and searching a database of potential intents corresponding to the given keywords. The database of potential intents and the keywords corresponding to the intents may be automatically mined from a collection of historical interaction recordings. In cases where the customer automation system 300 fails to understand the intent from the input, a selection of several intents may be provided to the customer in the user interface 305. The customer may then clarify their intent by selecting one of the alternatives or may request that other alternatives be provided.

After the customer's intent is determined, the flowchart 350 proceeds to an operation 365 where the customer automation system 300 loads a script associated with the given intent. Such scripts, for example, may be stored and retrieved from the script storage module 320. Such scripts may include a set of commands or operations, pre-written speech or text, and/or fields of parameters or data (also “data fields”), which represent data that is required to automate an action for the customer. For example, the script may include commands, text, and data fields that will be needed in order to resolve the issue specified by the customer's intent. Scripts may be specific to a particular contact center and tailored to resolve particular issues. Scripts may be organized in a number of ways, for example, in a hierarchical fashion, such as where all scripts pertaining to a particular organization are derived from a common “parent” script that defines common features. The scripts may be produced via mining data, actions, and dialogue from previous customer interactions. Specifically, the sequences of statements made during a request for resolution of a particular issue may be automatically mined from a collection of historical interactions between customers and customer service providers. Systems and methods may be employed for automatically mining effective sequences of statements and comments, as described from the contact center agent side, are described in U.S. patent spplication Ser. No. 14/153,049 “Computing Suggested Actions in Caller Agent Phone Calls By Using Real-Time Speech Analytics and Real-Time Desktop Analytics,” filed in the United States Patent and Trademark Office on Jan. 12, 2014, the entire disclosure of which is incorporated by reference herein.

With the script retrieved, the flowchart 350 proceeds to an operation 370 where the customer automation system 300 processes or “loads” the script. This action may be performed by the script processing module 325, which performs it by filling in the data fields of the script with appropriate data pertaining to the customer. More specifically, the script processing module 325 may extract customer data that is relevant to the anticipated interaction, with that relevance being predetermined by the script selected as corresponding to the customer's intent. The data for many of the data fields within the script may be automatically loaded with data retrieved from data stored within the customer profile 330. As will be appreciated, the customer profile 330 may store particular data related to the customer, for example, the customer's name, birth date, address, account numbers, authentication information, and other types of information relevant to customer service interactions. The data selected for storage within the customer profile 330 may be based on data the customer has used in previous interactions and/or include data values obtained directly by the customer. In case of any ambiguity regarding the data fields or missing information within a script, the script processing module 325 may include functionality that prompts and allows the customer to manually input the needed information.

Referring again to the flowchart 350, at an operation 375, the loaded script may be transmitted to the customer service provider or contact center. As discussed more below, the loaded script may include commands and customer data necessary to automate at least a part of an interaction with the contact center on the customer's behalf. In exemplary embodiments, an API 345 is used so to interact with the contact center directly. Contact centers may define a protocol for making commonplace requests to their systems, which the API 345 is configured to do. Such APIs may be implemented over a variety of standard protocols such as Simple Object Access Protocol (SOAP) using Extensible Markup Language (XML), a Representational State Transfer (REST) API with messages formatted using XML or JavaScript Object Notation (JSON), and the like. Accordingly, the customer automation system 300 may automatically generate a formatted message in accordance with a defined protocol for communication with a contact center, where the message contains the information specified by the script in appropriate portions of the formatted message.

### Personal Bot

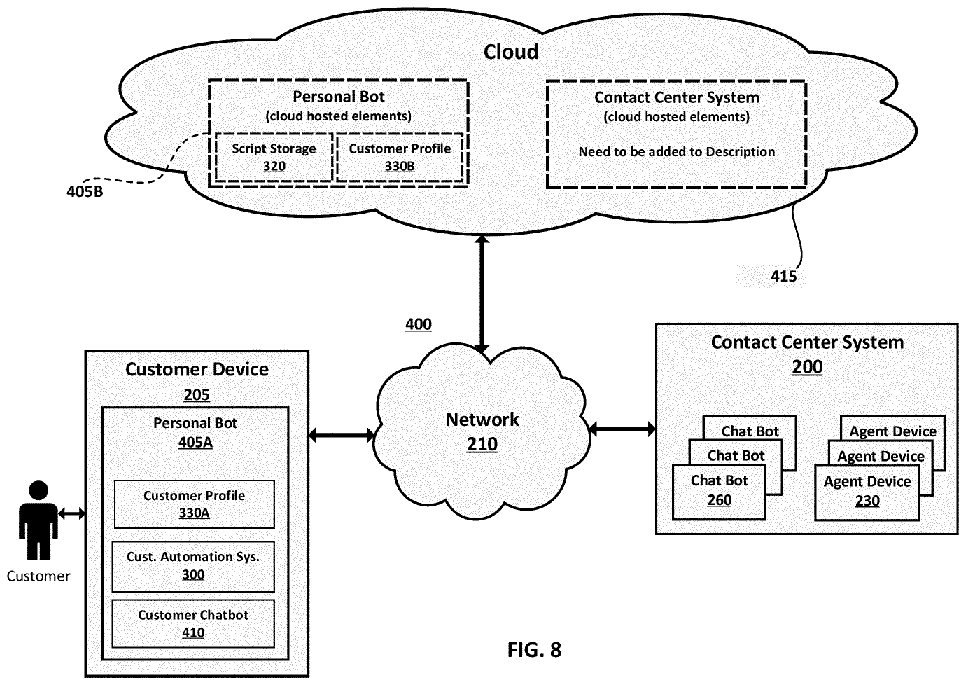

With reference now to FIG. 8, an exemplary system 400 is shown that includes an automated personal assistant or, as referred to herein, personal bot 405. As will be seen, the personal bot 405 is configured to automate aspects of interactions with a customer service provider on behalf of a customer. As stated above, present invention relates to systems and methods for automating aspects of the customer-side of the interactions between customers and customer service providers or contact centers. Accordingly, the personal bot 405 may provide ways to automate actions that customers are required to perform when contacting, interacting, or following up with contact centers.

The personal bot 405, as used herein, may generally reference any customer-side implementation of any of the automated processes or automation functionality described herein. Thus, it should be understood that, unless otherwise specifically limited, the personal bot 405 may generally employ any of the technologies discussed herein—including those related to the chatbots 260 and the customer automation system 300—to enable or enhance automation services available to customers. For example, as indicated in FIG. 8, the personal bot 405 may include the functionality of the above-described customer automation system 300. Additionally, the personal bot 405 may include a customer-side implementation of a chatbot (for example, the chatbot 260 of FIGS. 4 and 5), which will be referred herein as a customer chatbot 410. As will be seen, the customer chatbot 410 may be configured to interact privately with the customer in order to obtain feedback and direction from the customer pertaining to actions related to ongoing, future, or past interactions with contact centers. Further, the customer chatbot 410 may be configured to interact with live agents or chatbots associated with a contact center on behalf of the customer.

As shown in FIG. 8, in regard to system architecture, the personal bot 405 may be implemented as a software program or application running on a mobile device or personal computing device (shown as a customer device 205) of the customer. For example, the personal bot 405A may include locally stored modules, including the customer automation system 300, the customer chatbot 410, and elements of the customer profile 330A. The personal bot 405 also may include remote or cloud computing components (e.g., one or more computer servers or modules connected to the customer device 205 over a network 210), which may be hosted in a cloud computing environment or cloud 415 (see cloud hosted elements of the personal bot 405B). For example, as shown in the illustrated example, the script storage module 320 and elements of the customer profile 330B may be stored in databases in the cloud 415. It should be understood, however, that present embodiments are not limited to this arrangement and, for example, may include other components being implemented in the cloud 415.

Accordingly, as will be seen, embodiments of the present invention include systems and methods for automatically initiating and conducting an interaction with a contact center to resolve an issue on behalf of a customer. Toward this objective, the personal bot 405 may be configured to automate particular aspects of interactions with a contact center on behalf of the customer. Several examples of these types of embodiments will now be discussed in which resources described herein—including the customer automation system 300 and customer chatbot 410—are used to provide the necessary automation. In presenting these embodiments, reference is again made to previously incorporated U.S. application Ser. No. 16/151,362, entitled “System and Method for Customer Experience Automation”, which includes further background and other supporting materials.

### p Pre-Interaction Automation

Embodiments of the present invention include the personal bot 405 and related resources automating one or more actions or processes by which the customer initiates a communication with a contact center for interacting therewith. As will be seen, this type of automation is primarily aimed at those actions normally occurring within the pre-contact or pre-interaction stage of customer interactions.

For example, in accordance with an exemplary embodiment, when a customer chooses to contact a contact center, the customer automation system 300 may automate the process of connecting the customer with the contact center. For example, present embodiments may automatically navigate an IVR system of a contact center on behalf of the customer using a loaded script. Further, the customer automation system 300 may automatically navigate an IVR menu system for a customer, including, for example, authenticating the customer by providing authentication information (e.g., entering a customer number through dual-tone multi-frequency or DTMF or “touch tone” signaling or through text to speech synthesis) and selecting menu options (e.g., using DTMF signaling or through text to speech synthesis) to reach the proper department associated with the inferred intent from the customer's input. More specifically, the customer profile 330 may include authentication information that would typically be requested of customers accessing customer support systems such as usernames, account identifying information, personal identification information (e.g., a social security number), and/or answers to security questions. As additional examples, the customer automation system 300 may have access to text messages and/or email messages sent to the customer's account on the customer device 205 in order to access one-time passwords sent to the customer, and/or may have access to a one-time password (OTP) generator stored locally on the customer device 205. Accordingly, embodiments of the present invention may be capable of automatically authenticating the customer with the contact center prior to an interaction. Other examples of pre-interaction automation are described in U.S. patent application Ser. No. 16/730,698 entitled “Systems and Methods Relating to Customer Experience Automation,” filed in the United States Patent and Trademark Office on Dec. 30, 2019, the entire disclosure of which is incorporated by reference herein.

### During-Interaction Automation

Embodiments of the present invention further include the personal bot 405 and related resources automating the actual interaction (or aspects thereof) between the customer and a contact center. As will be seen, this type of automation is primarily aimed at those actions normally occurring within the during-contact or during-interaction stage of customer interactions.

For example, the customer automation system 300 may interact with entities within a contact center on behalf of the customer. Without limitation, such entities may include automated processes, such as chatbots, and live agents. Once connected to the contact center, the customer automation system 300 may retrieve a script from the script storage module 320 that includes an interaction script (e.g., a dialogue tree). The interaction script may generally consist of a template of statements for the customer automation system 300 to make to an entity within the contact center, for example, a live agent. In exemplary embodiments, the customer chatbot 410 may interact with the live agent on the customer's behalf in accordance with the interaction script. As already described, the interaction script (or simply “script”) may consist of a template having defined dialogue (i.e., predetermined text or statements) and data fields. As previously described, to “load” the script, information or data pertinent to the customer is determined and loaded into the appropriate data fields. Such pertinent data may be retrieved from the customer profile 330 and/or derived from input provided by the customer through the customer interface 305. According to certain embodiments, the customer chatbot 410 also may be used to interact with the customer to prompt such input so that all of the necessary data fields within the script are filled. In other embodiments, the script processing module 325 may prompt the customer to supply any missing information (e.g., information that is not available from the customer profile 330) to fill in blanks in the template through the user interface 305 prior to initiating a communication with the contact center. In certain embodiments, the script processing module 325 may also request that the customer confirm the accuracy of all of the information that the customer automation system 300 will provide to the contact center.

Once the loaded script is complete, for example, the interaction with the live agent may begin with an initial statement explaining the reason for the call (e.g., “I am calling on behalf of the customer's customer, Mr. Thomas Anderson, regarding what appears to be double billing.”), descriptions of particular details related to the issue (e.g., “In the previous three months, his bill was approximately fifty dollars. However, his most recent bill was for one hundred dollars.”), and the like. While such statements may be provided in text to the contact center, it may also be provided in voice, for example, when interacting with a live agent. In regard to how such an embodiment may function, a speech synthesizer or text-to-speech module 340 may be used to generate speech to be transmitted to the contact center agent over a voice communication channel. Further, speech received from the agent of the contact center may be converted to text by a speech-to-text converter 342, and the resulting text then may be processed by the customer automation system 300 or customer chatbot 410 so that an appropriate response in the dialogue tree may be found. If the agent's response cannot be processed by the dialogue tree, the customer automation system 300 may ask the agent to rephrase the response or may connect the customer to the agent in order to complete the transaction.

While the customer automation system 300 is conducting the interaction with the live agent in accordance with the interaction script, the agent may indicate their readiness or desire to speak to the customer. For the agent, readiness might occur after reviewing all of the media documents provided to the agent by the customer automation system 300 and/or after reviewing the customer's records. In exemplary embodiments, the script processing module 325 may detect a phrase spoken by the agent to trigger the connection of the customer to the agent via the communication channel (e.g., by ringing the customer device 205 of the customer). Such triggering phrases may be converted to text by the speech-to-text converter 342 and the natural language processing module 310 then may determine the meaning of the converted text (e.g., identifying keywords and/or matching the phrase to a particular cluster of phrases corresponding to a particular concept). Other examples of during-interaction automation are described in U.S. patent application Ser. No. 16/730,698 entitled “Systems and Methods Relating to Customer Experience Automation,” which, as previously stated, is incorporated by reference herein.

### Customer Privacy Automation

Embodiments of the present invention further include the personal bot 405 and related resources functioning to automate aspects related to privacy for a customer. More particularly, the customer automation system 300 of the personal bot 405 may allow customers to manage privacy or data sharing with organizations and corresponding contact centers.

In accordance with exemplary embodiments, for example, the customer automation system 300 may facilitate the customer managing settings for privacy and data sharing (or simply “data sharing settings”) globally, for example, across all providers and data types. The customer is enabled to manage data sharing settings on a per-organization basis by choosing which data type to share with each specific organization. As another example, the customer is enabled to manage data (e.g., data within a customer profile) according to data type. In such cases, the customer may choose which organization or which types of organizations to share each particular data type. In more detail, each field of data in the customer profile may be associated with at least one permission setting (e.g., in exemplary embodiments, each field of data may have a different permission setting for each provider). Further, user interfaces may be provided through the customer device 205 that allow the customer to adjust data sharing settings and/or permission settings. Within such user interfaces, data sharing settings or permission settings may be made adjustable on a per data type, per organization basis, per type of organization basis, etc.

In accordance with exemplary embodiments, the customer automation system 300 may offer a plurality of levels for data sharing settings or permission settings. For example, in one embodiment, three different levels of permission settings are offered: share data, share anonymous data, and do not share any data. Anonymous data may include, for example, genericized information about the customer such as gender, zip code of residence, salary band, etc. Some aspects of embodiments of the present invention may enable compliance with the General Data Protection Regulation (GDPR) of the European Union (EU). In other embodiments, the customer automation system 300 provides functionality for a customer to exercise the “right to be forgotten” with all organizations (e.g., providers and/or business) that the customer has interacted with. In other embodiments, the customer can switch on/off the sharing of each of the data types. When selecting a specific data type, the customer can select to send this data in an anonymized form to the provider or to delete the previously shared data with a particular organization. Additionally, the customer can delete all data types that were previously shared with an organization, for example, by clicking on the ‘trash’ button provided in the customer interface. According to one embodiment of the present invention, the deletion of the data may include the customer automation system 300 loading an appropriate script from the script storage module 320 in order to generate a formal request to the associated organization to delete the specified data. As noted above, for example, the customer automation system 300 may be used to make such request by initiating a communication with a live agent of the organization or by accessing an application programming interface provided by the organization.

### Post-Interaction Automation

Embodiments of the present invention include methods and systems for identifying outstanding matters or pending actions for a customer that need additional attention or follow-up, where those pending actions were raised during an interaction between the customer and a contact center. Once identified, other embodiments of the present invention include methods and systems for automating follow-up actions on behalf of the customer for moving such pending actions toward a resolution. For example, via the automation resources disclosed herein, the personal bot 405 may automate subsequent or follow-up actions on behalf of a customer, where those follow-up actions relate to actions pending from a previous interaction with a customer service provider. As will be appreciated, this type of automation is primarily aimed at those actions normally occurring within the post-contact or post-interaction stage of a customer interaction, however it also includes the automation of action that also can be characterized as preceding or prompting a subsequent customer interaction. Other examples of post-interaction automation, including an auto-follow-up functionality are described in U.S. patent application Ser. No. 16/730,646 entitled “Systems and Methods Relating to Customer Experience Automation,” filed in the United States Patent and Trademark Office on Dec. 30, 2019, the entire disclosure of which is incorporated by reference herein.

### Personalized Customer Profiles

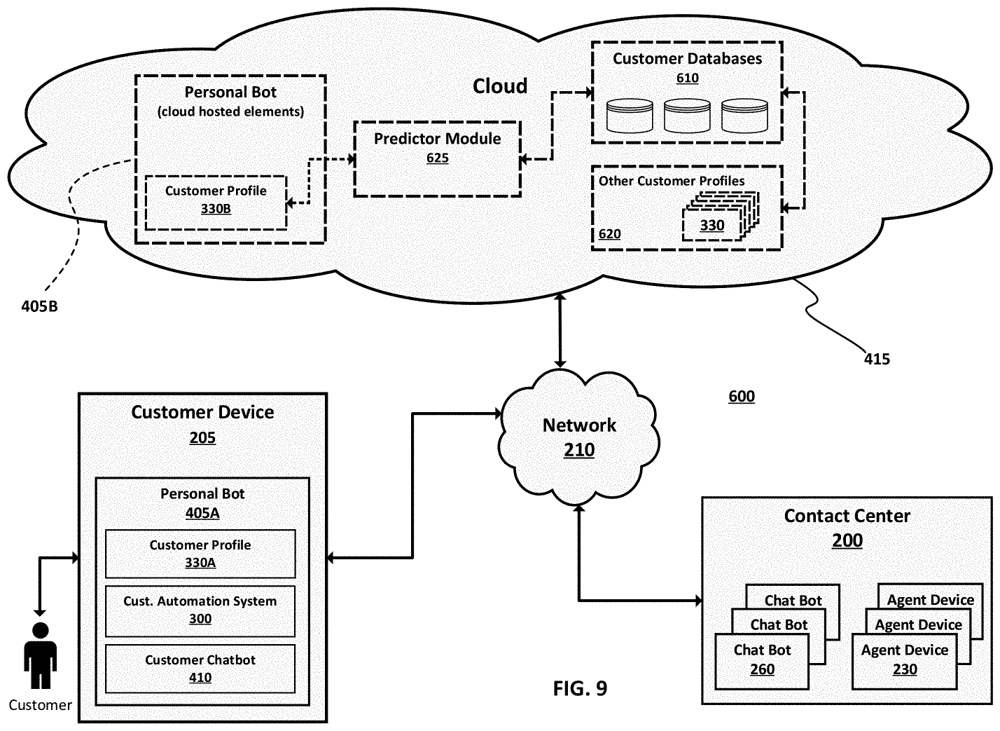

With reference now to FIG. 9, attention will now focus on aspects of the present invention aimed at gathering, maintaining, analyzing, and using customer data and profiles. For example, systems and methods are disclosed for building highly personalized customer profiles that facilitate the mining and use of customer data. As will be seen, the customer profiles of the present invention may be used in several ways, including implementing personalized customer services aimed at improving the customer experience.

By way of background, customer service providers or contact centers have long maintained data on customers, with data pertaining to a particular customer often being stored in a customer profile. Once stored, this data then may be used by the contact center to manage certain aspects of the customer relationship. For example, contact centers may use customer profiles to facilitate aspects of incoming interactions. However, conventional customer profiles are often limited in scope, for example, including only basic information about customers, with perhaps some partial history and preferences. Further, conventional customer profiles have been structure and utilized in ways that have constrained customer-oriented advances. In several ways, which will now be touched on, conventional systems and methods associated with customer data and profiles have proved inadequate at providing the level of personalization required to deliver advanced customer-oriented functionality.

First, conventional customer profiles are overly static. That is, in conventional systems, customer profiles are not regularly updated and, thus, generally ill-equipped at providing helpful real-time clues as to a particular customer's present situation. What's more, conventional systems are often not configured to take into account the most current or relevant customer data, and this deficiency undermines the usefulness of customer behavior models and other analytics. Second, while advances in data collection and analysis have increased the amount and variety of data being collected about customers and interactions with contact centers, conventional systems have failed to leverage this new data abundance into customer centric features. For example, large repositories of customer interaction data could be analyzed to determine predictive insights useful at providing personalized customer services, yet conventional systems continue to emphasize the use of such data toward improving contact center performance, virtually ignoring the customer experience. Third, conventional systems also fail to properly aggregate data sources. As will be appreciated, opportunities to make cross-category data insights are impeded when different types of customer data are maintained in separate databases. Further, incomplete customer profiles degrade the ability of the enterprise to respond to and service customers according to particular needs.

As a result of these and other issues, current data systems related to the maintenance, analysis, and use of customer data and profiles have been unsuccessful at promoting customer-oriented advances in the field. This failure is particularly apparent in those instances where the delivery of new services involves recognizing or predicting a customer's current status or emotional state.

To address this situation, the present invention discloses improved systems and methods for gathering, maintaining, analyzing, and using customer data and profiles. For example, systems and methods are disclosed for building highly personalized customer profiles that facilitate the analysis and mining of customer data. From there, the customer profiles of the present invention may be used in several ways, including implementing personalized customer services aimed at improving the customer experience and/or removing the interaction “friction” that normally occurs between customers and contact centers. On the customer-side of the interaction, for example, routing strategies can become more personalized in accordance with specific customer preferences and a present emotional state, thereby making routing more customer centric. On the contact center-side of the interaction, the present customer profiles also may be used toward improving contact center operations, such as, for example: making call forecasting more context oriented and reliable; improving handle time predictions and queue optimization; improving outbound campaigns (e.g., by targeting customers who are more likely to see value in and respond positively to a particular offer); improving agent assists or automated processes with more customer personalization (e.g., by anticipating customer needs to reduce the steps needed to complete an interaction and/or alleviate need for customer to provide information during an interaction); and improving customer communications through greater personalization.

Before proceeding, several terms will first be presented and defined in accordance with their intended usage. As used herein, “customer experience” generally refers to the experience a customer has when interacting with a customer service provider and, more specifically, refers to the experience a customer has during an interaction, i.e., as he interacts with a contact center. As used herein, “customer data” refers to any information about a customer that can be gathered and maintained by a customer service provider. As provided below, such customer data may be categorized with reference to several different information types. In discussing how such data is stored, reference may be made to a “customer profile” (such as customer profile 330), which, as used herein, refers a collection or linking of data elements relevant to a particular customer. Reference may also be made to “customer databases” (such as customer databases 610), which, as used herein, refers to a collection or linking of data elements relevant to or gathered from a large population of customers (or “customer population”). Further, as stated, reference may be made interchangeably to contact center or customer service provider. It should also be understood that, unless otherwise specifically limited, reference to a contact center includes reference to the associated organization or enterprise on behalf of which the customer services are being provided. This includes arrangements in which the associated organization or enterprise is providing the customer services through an inhouse contact center as well as arrangements in which a third-party contact center contracts with the organization or enterprise for providing such services.

With specific reference to FIG. 9, an exemplary system 600 is shown that includes a personal bot 405 running on a customer device 205, where the personal bot 405 facilitates the creation and maintenance of a personalized customer profile database or module (or simply “customer profile”) 330. As shown in the example, the customer profile 33 may include elements 330A local to the customer device 205 as well as remote or cloud hosted elements 330B. The system 600 may further include customer databases 610, other customer profiles 620, and a predictor module 625. (Note that further information in regard to the system 600 of FIG. 9 may be found above in relation to the system 400 of FIG. 8, which includes several similar features that are not described again here for brevity's sake.)

For the sake of an example, a customer may have a mobile device or smart phone on which is running an application implementing local aspects of the personal bot 405. In setting up a customer profile 330, the personal bot 405 may serve as a means for the customer to input information. For example, the personal bot 405 may prompt and accept direct input of information from the customer by voice or text. The customer may also upload files to the personal bot 405 or provide the personal bot 405 with access to pre-existing databases or other files from which information about the customer may be obtained.

The personal bot 405 also may gather information about the customer by monitoring customer behavior and actions through the customer's use of the device 205. For example, the personal bot 405 may collect data that relates to other activities that the customer performs through the device, such as email, text, social media, internet usage, etc. The personal bot 405 also may monitor and collect data from each of the interactions the customer has with customer service providers, such as a contact center system 200, through the customer device 205. In this way, data may be collected from interactions occurring with many different contact centers.

In use, at the conclusion of each interaction, the personal bot 405 of the present invention may update the profile of the customer in accordance with data gleamed from that interaction. Such interaction data may include any of the types of data described herein. As discussed more below, once the profile is updated, it will include data associated with that most recent interaction as well as data from other past interactions. This updated or current dataset then may be analyzed in relation to one or more customer databases 610, which, as used herein, are data repositories housing customer data, such as interaction data relating to past interactions, from a large population of other customers. The analysis may be performed with the predictor module 625, which may include a machine learning algorithm that is configured to find data driven insights or predictors (or, as used herein, “interaction predictors”).

As used herein, the interaction predictors represent a behavioral factor attributable to the customer given the first interaction type. As will be seen, the behavioral factor of the interaction predictor may include an emotional state, behavioral tendency, or preference for a particular customer given a type of interaction (also “interaction type”). The interaction predictor may be generated and applied in real time, for example, by the predictor module 625. Alternatively, the interaction predictors may be determined and stored in the customer profile 330 of a given customer as a way to augment or further personalize the profile. Such stored interaction predictors then may be applied in future interactions involving the customer when found relevant thereto. The predictor module 625 may be a module within the personal bot 405 or, as illustrated, may be a separate module that communicates with the personal bot 405.

Thus, in general, a personal bot 405 may gather relevant information as a customer interacts with contact centers on his mobile device. The personal bot 405 may gather other types of information, as described above, and then may aggregate that data to build a highly personalized customer profile 330. As will be appreciated, when a customer profile is created and maintained by a contact center, it is generally limited to data pertaining to past interactions occurring between a customer and a particular contact center. In the present invention, with the customer profile 330 being created and maintained on the customer-side of the interaction, the collection of data is not so limited. Instead data may be gathered from any of the interactions involving the customer, which will typically result in a much richer set of data as it reflects a wider spectrum of interactions.

The system of FIG. 9 may include a collection of data that is referred to other customer profiles 620. As will be appreciated, when versions of the personal bot 405 are used by many customers, data may be anonymously gleaned from the many corresponding customer profiles 330 (as shown within the other customer profiles 620) so to create rich repositories of customer data. For example, such data repositories may include information taken from a multitude of past interactions covering a wide spectrum of both customers and customer service providers. As indicated, this data may be parsed and aggregated into the customer databases 610 so to provide particular datasets that facilitate machine learning and other data driven analytics.

While the customer profiles 330 of the present invention may include any type of customer data, exemplary embodiments may include several primary categories of information. These categories include: biographic personal data (or simply “personal data”); past interaction data (or simply “interaction data”); feedback data; and choice data. As will also be seen, present systems and methods may predict or infer certain behavior traits, preferences, or tendencies about a customer through data analytics. Such predictions—which are introduced above as “interaction predictors”—may also be stored within a customer profile 330 and then utilized in subsequent interactions as a way of enhancing personalization and facilitating other customer centric features. Alternatively, the interaction predictors may be generated contemporaneously and used in relation to an incoming interaction.

It should be appreciated that, while the data stored within the customer profile 330 may be discussed in categories, the customer profile 330 of the present invention may be structured to include an aggregated collection of information that may be analyzed as a whole. Further, it should be understood that the data within a customer profile 330 may be stored locally on a customer device 204, remotely in the cloud, or some combination thereof. Present systems and methods may further include functionality that protects a customer's data from unwanted disclosure. In general, the data stored within the profile of a customer is controlled by the customer, with the customer deciding what information is to be shared during each interaction with an outside organization or enterprise. Thus, before any customer profile data is shared with an outside entity, such as a contact center or other organization, present systems and methods may first seek to confirm with the customer that such sharing is intended. Additional functionality may enable the partial sharing and use of customer information in ways that maintain a customer's anonymity.

In regard to the types of data stored within a customer profile 330, a first category is referred to herein as personal data. This type of data may include general information about the customer that is generic to all interactions with customer service providers, for example, name, date of birth, address, Social Security number, social media handles, etc. This type of data may also include biographical information, such as education, profession, family, pets, hobbies, interest, etc. This category of data may also include data that is specific to particular contact centers. For example, data related to authentication information specific to the different companies that the customer does business with, including usernames and passwords, may be included. Such personal data may be added to a customer profile 330 when a customer is registering with or setting up the mobile application, i.e., personal bot 405, on his mobile device. For example, a prompt by the personal bot 405 may be provided that initiates input of the necessary information. When setting up the mobile application, the customer may be asked via a user interface generated on his customer device for certain information. Once gathered, the personal data of the customer may be made part of the customer's profile. The customer may update this information at any time. As will be seen, aspects of the personal data may be used to find similarities with other customers, which may be used when making predictions about the customer.

The customer profile 330 of the present invention further may include a category of information referred to herein as past or historical interaction data (or simply “interaction data”). As used herein, this refers to data pertaining to or measuring aspects of previous customer interactions. Accordingly, such data may include a complete historical record of data reflecting all past interaction between a customer and any contact center. Interaction data may include any of the types of information described herein relating to interactions, including type or intent of the interaction, information associated with the dialogue between the agent and customer, such as a recording or transcript, information related to the agent, including agent type and other characteristics, information about results of the interaction, notes provided by the customer or the agent, files shared during the interaction, length of the interaction, call transfers or holds that took place during the interaction, emotional state of the customer, and others. The customer profile 330 may be updated after each new interaction with such interaction data taken therefrom. The interaction data may further include feedback data and choice data, which are discussed below.

The customer profile 330 of the present invention further may include feedback data, which, as used herein, refers to feedback received from a customer that relates to a particular interaction with a contact center. As will be appreciated, feedback and survey responses may provide a valuable indication as to what went right or wrong in an interaction. Often such feedback is provided by customers at the end of an interaction in response to surveys or ratings requests. In accordance with the present invention, any type of feedback, including customer satisfaction score or ratings, provided by a customer at the conclusion of an interaction is saved within a customer profile 330 as feedback data. Systems and methods of the present invention may include functionality wherein the personal bot 405 gathers such feedback data for storage within the customer profile 330. The personal bot 405 may do this via passively recording such feedback when provided by the customer in response to a query initiated by an outside entity, such as a contact center. The personal bot 405 also may actively prompt for such feedback at the end of an interaction and record any responses provided by the customer.

Another type of feedback data may include what will be referred to herein as “conclusory statement data”. Conclusionary statement data may include data related to statements made by a customer as the interaction is concluding, where the meaning of the statements is extracted by natural language processing. Conclusory statement data, thus, may be seen as a type of inferred feedback, i.e., feedback inferred from statements made while the interaction is concluding.

For example, the personal bot 405 may gather such conclusory statement data by analyzing statements or comments made by the customer at the conclusion of an interaction and, where appropriate, inferring customer feedback from the analysis of those statements. Specifically, such conclusory statements by the customer may be extracted and analyzed via natural language processing and, when the customer's statements are clear enough to infer feedback with sufficient confidence, the inferred feedback may be gathered for storage within the customer profile 330 as a type of feedback or interaction data. As such statements are often highly relevant as to how the customer feels at the conclusion of an interaction, such inferences can prove useful, particularly where no other rating or survey response is provided by the customer for a given interaction. According to exemplary embodiments, for example, such feedback data may be used to assist contact centers in deciding on the level of service that a customer should receive in a next interaction.

The customer profile 330 of the present invention further may include choice data, which, as used herein, refers to data that relates to a selection or choice made by the customer in selecting an agent. More specifically, choice data refers to automatically learned preferences of the customer that are based on the customer's manual selection of one agent or type of agent over another agent or type of agent. For example, the present invention may include functionality that permits customers to manually choose their own agent from alternatives provided to them via the customer's computing device. Thus, a customer may be allowed to review a collection of agent profiles of available agents and then prompted to select one of those agents to handle the customer's present or incoming interaction. Alternatively, instead of being presented with a choice between individual agents, the customer may be prompted to select from different categories or types or agents. The categories, for example, may describe personality types of the agents. After the customer makes several such selections, systems and methods of the present invention could begin to learn what type of agent a customer most and least prefers. In example embodiments, such learning can be bolstered by cross-referencing interaction data that describes the actual outcomes of those interactions and/or subsequent feedback provided by the customer. In certain cases, this type of analysis may produce insights into preferences that even the customer is not fully aware of having, which may be leveraged to improve predictive routing for that customer in future interactions.

The data stored within the customer profile 330 of the present invention may further include interaction predictors. As used herein, an interaction predictor is defined as a behavioral characteristic, preference, tendency, or other customer trait that, because of correlations or patterns found to exist within a dataset of relevant customer information, can be inferred upon or attributed to a given customer. As will be seen, some interaction predictors may be used to predict broad traits, behaviors, or tendencies that are common to many other customers, while other interaction predictors are highly contextual and specific to particular type of interaction, such as, for example, interactions involving a particular intent, emotional state, or contact center. As will be appreciated, the interaction predictors of the present invention offer a way to add detail to a customer profile 330 with assumed characteristics that then may be used to personalize services and facilitate interactions.

In deriving the interaction predictors, any of the systems and methods described herein may be used. In exemplary embodiments, as shown in FIG. 9, the personal bot is configured to communicate with a predictor module 625 that includes an artificial intelligence or machine learning algorithm. As will be appreciated, the machine learning algorithm may be applied to a dataset of customer information and, therefrom, learn knowledge in the form of data patterns correlating one or more input factors to one or more outcomes, with those correlations forming the basis of the interaction predictors. For example, the machine learning algorithm in the predictor module 625 may extract such patterns based on monitored customer actions and associated outcomes. Once such knowledge is acquired, it may be put to use in the form of the present interaction predictors to predict outcomes when new inputs are encounters, such as those presented in an incoming interaction.

Any one or more existing machine learning algorithms may be invoked to do such learning, including without limitation, linear regression, logistic regression, neural network, deep learning, Bayesian network, tree ensembles, and the like. For example, linear regression assumes that there is a linear relationship between input and output variables, whereas, in the case of neural networks, the learning is done via a backward error propagation where the error is propagated from an output layer back to an input layer to adjust corresponding weights of inputs to the input layer.

For the sake of providing examples as to how such interaction predictors may be derived for a given customer, reference will now be made to an exemplary customer “Adam”. To begin the process, the machine learning algorithm of the predictor module 625 may be configured to monitor a given dataset. This dataset may be obtained from any of the several sources of data described herein. For example, one or more data sources may be derived from data maintained within Adam's own customer profile (i.e., customer profile 330). The machine learning algorithm may have access to and monitor several of the types of data stored within Adam's customer profile, e.g., the personal data, interaction data, feedback data, and/or choice data.

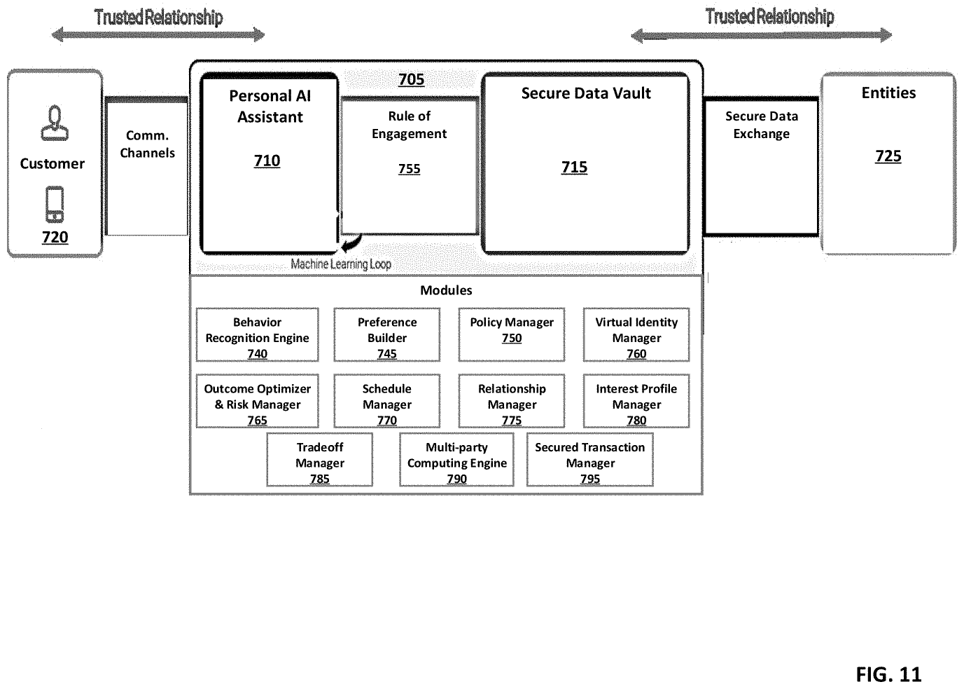

For example, to gain insights on what works best for Adam during interactions, the machine leaning algorithm could monitor (i.e., use as a training dataset) Adam's interaction data and identify particular factors that consistently correlate with more successful outcomes. As a more specific example, the machine learning algorithm of the predictor module 625 may monitor the choice data within Adam's customer profile—i.e., the agents that Adam selects when given a choice—to identify patterns relating to the type of agents Adam prefers. Once identified, such a pattern could become the basis for an interaction predictor, which the predictor module 625 would then cause to be stored within the Adam's customer profile. When circumstances later arise that are relevant to the interaction predictor, the interaction predictor could be recalled from Adam's customer profile and used to facilitate choices as to how best to provide services to Adam. Specifically, for example, the interaction predictor could be used to predict which agent out of those available would be most preferable to Adam, as will be discussed more below in relation to FIG. 11.

In accordance with other aspects of the present invention, the machine learning algorithm of the predictor module 625 may also monitor and derive datasets from one or more customer databases 610, which, as used herein, refer to a collection of customer data gathered from “other customers”. For example, the customer databases 610 may include data gathered from a large customer population. Such customer databases 610 may store any of the customer data types discussed herein and include a multitude of samples collected from a customer population. As an example, one of the customer databases 610 may include data aggregated from the personalized customer profiles of the present invention, where those customer profiles 330 correspond to customers within a customer population (with those customer profiles 330 being represented by those depicted within the other customer profiles 620).

In accordance with an exemplary embodiment, the machine learning algorithm may monitor or derive training datasets from the customer databases 610, such as a dataset that includes interaction data taken from previous interactions between customers within the customer population and different contact centers. The machine learning algorithm may then analyze the data within this database to identify patterns in which particular factors consistently correlate with certain outcomes. As before, such patterns or correlations may then become the basis for identifying interaction predictors. Thus, based on similarities found to exist between Adam and the other customers within the customer population, the predictor module 625 may cause one or more interaction predictors to be applied to or used in connection with Adam.

When identified from a large database of customer information, interaction predictors may be found to be predictively relevant to the customer population as a whole or to a group or subpopulation defined within the customer population. Thus, in accordance with the present invention, the applicability of such interaction predictors to any particular customer, such as Adam, may be predicated on a degree of similarity found to exist between Adam and a given subpopulation. Thus, the predictor module 625 may attribute such an interaction predictor to Adam only after determining that a sufficient degree of similarity exists between Adam and the customers within the corresponding subpopulation or, put another way, whether Adam is determined to be member of that subpopulation. Upon determining that a sufficient level of similarity exists between Adam and that subpopulation, the predictor module 625 may add the particular interaction predictor to Adam's customer profile, where it will remain until further machine learning makes necessitates its modification or removal.

As a general example, a customer database 610 that stores interaction data may include data collected from interactions between a customer population and many different contact centers. A predictive correlation or other data driven insight—generally referred to herein as an interaction predictor—is then identified via the machine learning algorithm of the predictor module 625 by monitoring and analyzing the customer database 610. Through this analysis, it may further be determined that the identified interaction predictor is only applicable to a particular subpopulation within the customer population. In accordance with the present invention, the interaction predictor then is selectively applied to a particular customer if it is determined that the customer is a member of the given subpopulation or, at least, sufficiently similar to another customer within the given subpopulation.

Whether gleamed from the customer's own past behavior, based on the past behavior of other similar customers, or some combination thereof, once determined, the interaction predictors may be applied to a particular customer (for example, saved within his customer profile 330) and then used to make certain insights or predictions about that customer in order to enhance aspects of customer service. As will be appreciated, the interaction predictors stored within a customer profile 330 may be dynamically updated as needed so that those currently stored reflect changes, updates, or additions to the underlying datasets. For example, in an interaction that just concluded, customer Adam made an agent selection that significantly modifies the choice data stored in his customer profile. According to exemplary embodiments, the machine learning algorithm may continue to monitor Adam's customer profile (and choice data included therein) and modify the interaction predictors in Adam's customer profile as needed given the modification to the underlying dataset (i.e., the dataset as modified by his recent interaction).

Changes to data within the customer databases 610 may also modify how interaction predictors are applied to Adam. For example, the addition of new interaction data within a customer database may modify interaction predictors that are identified therein. To the extent the modification impacts any of the interaction predictors found applicable to Adam, Adam's customer profile would be updated to reflect that. As another example, if Adam inputs new personal information, such as a change in professional status or where he lives, existing similarities between Adam and certain groups within the customer population may be altered. As those similarities change, the interaction predictors that are attributed to Adam or used in interactions involving Adam will be updated to reflect the changed similarities.

With the data and the interaction predictors stored in a given customer profile 330, aspects of the present invention may be used to facilitate the personalized delivery of customer services related to a present or incoming interaction. For example, contextual information or factors related to the incoming interaction may be identified and, based on those identified factors, predictions can be made about the customer by determining which of the stored interaction predictors are applicable. Alternatively, it should also be understood that such predictions about the customer may be made contemporaneously with the incoming interaction via the machine learning algorithm (or models developed therefrom) finding similarities in the contextual information around the incoming interaction and past interactions experienced by the customer and/or other similar customers within the customer databases 610. In either case, one or more interaction predictors applicable to the incoming interaction may be used to facilitate the delivery of services to the customer during the incoming interaction.

In accordance with exemplary embodiments, the relevant interaction predictors along with any other relevant information from the customer profile 330 may be packaged within an interaction profile and then delivered to a contact center for use thereby. The contact center may then use this packaged data or interaction profile to facilitate decisions as to the nature of services that should be provided to the customer during the incoming interaction. For a description of further embodiments covering exemplary implementations as to how this customer data and profiles may be created, maintained, and used, see U.S. patent application Ser. No. 16/730,698 entitled “Systems and Methods Relating to Customer Experience Automation,” which, as previously stated, is incorporated by reference herein. As discussed below, this same type of customer data may be gathered and maintained in a secure database and then protected, managed, and used on customer's behalf via a personalized data custodian application. As will be appreciated, this “data custodian” may share certain functionalities with the above-described personal bot. However, as will be seen, the data custodian is directed more toward empowering customers to own and control their own personal data in a secure environment while also selectively sharing that data so to leverage new capabilities available in the ever-growing digital marketplace.

### Personal Data Custodian

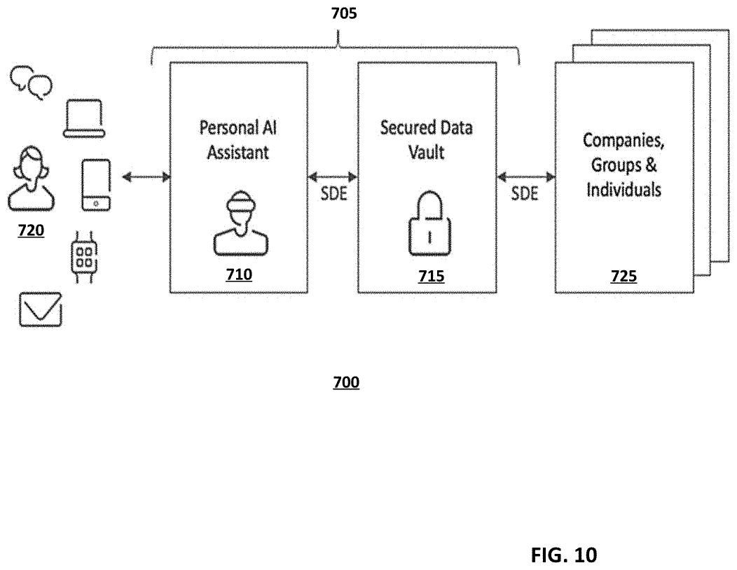

With reference now to FIGS. 10-11, aspects described herein may be further utilized toward the protecting personal information and data of consumers or customers while also enabling this data to be fully utilized by on the customer's behalf. This section will first discuss the challenges consumers face in relation to their personal information, particularly in trying to serve each of these often-competing objectives. A discussion of the novel solution proposed by the present application will follow. Finally, a summary of the benefits will be provided.

In today's data and media rich environment, customers are constantly targeted by marketing campaigns related to the multitudes of available products and services. Such marketing campaigns can include robocalls, emails, direct messages, mail, text, and other targeted advertising Merchants try to pursue any and all possible avenues to persuade customers to buy their products, to the extent that it becomes burdensome on the customer. Making matters worse, the abundance of available personal data allows marketers to accumulate multiply datapoints around most every consumer—phone number, email address, physical address, purchasing history, interests, real-time intents, and so on—which are then used to find new ways to contact them. A customer may provide consent to certain merchants to use aspects of their personal data—either knowingly or by not paying attention to the fine print of an agreement—and the data stitched about that customer increases, enabling marketers to target them in real-time whenever an intent becomes known. A significant problem with this arrangement is that customers are not in control of or feel they own their own personal data. Related to this, customers feel that they have no oversight when sharing aspects of their personal data nor able to restrict unwanted contacts.

Exacerbating this problem is the growing power of AI and the collection of ever more data. Digital merchants now leverage the power of AI to collect and stitch together more and more data to describe customers so that customers lose their anonymity and are targeted more often and in new ways. This unbalanced use of AI technology represents an unfair advantage for the companies and merchants, who are not merely offering alternatives to customers with the use of AI technology, but often persuading or influencing customers to behave in ways that are actually against their own interests.

However, the choice for a customer to refrain from sharing aspects of their personal data is not a practicable solution either. This is because to do so would prevents the customers from leveraging the new opportunities provided in the digital marketplace. At the same time, for a customer to maintain and control their personal data (including their own Personal Identifiable Information or “PII”, which is intended as part of any general references herein to “personal data”) across hundreds of digital companies, organizations, and enterprises is not possible or, at the very least, would be extremely time consuming for the customer to do manually.

Currently customers sharing their own data without encryption with hundreds or even with thousands of companies, enterprises, and organizations—which may be generally referred to herein as entities—and simply rely on the entity's ability to secure and keep their data current. Customers are not able to control and manage their data, and the entity considers the data as its own asset. Customers generally are not able to mandate that those entities share and expunge their personal data after it is no longer required. Thus, customer currently have not effective tool to control the use of their personal data, including their PII, and companies do not maintain this data on behalf of the customers, i.e., with the customer's best interest in mind. Unfair or unbalanced use of AI makes the customers vulnerable more than ever before. While customers are becoming more aware of the value and the importance of their personal data, currently they do not have proper tools that make secure and control that data transparent and trustworthy.

As proposed in the present application, systems and methods are disclosed for implementing a personal data manager or custodian that can handle the complexity and security requirements to digitally share personal data of a customer in real time while protecting the customer's identity and promoting the customer's interests in the digital marketplace. As will be seen, the personal data manager or custodian of the present invention—which will be referred to herein generally as a “personal data custodian” or simply “data custodian”—will allow customers to put their personal data, including PII, behavioral data, historical data, preferences, consents, and other data into a secure digital vault that is then managed via a AI-enhanced, personalized digital assistant or bot (which will be referred to as a “personal assistant”) that then manages, uses, and shares such data through trusted relationships and in other ways directly controlled by the customer. Exemplary embodiments include the data custodian becoming a virtual representation of the customer—a kind of “digital twin”—that transacts business and other actions on behalf of the customer and represents the customer's interests. In accordance with exemplary embodiments, entities transacting business with the data custodian will not be able to see or access the individual or customer for whom is the data custodian is working, but will be able to do business with a virtual identity of customer, as provided by the data custodian. The data custodian of the present invention, thus, may be described as working in ways similar to that of a legal trust. That is, from the outside, the beneficiary of the trust—like the customer—remains invisible while the trust carries out actions and transactions on behalf of the beneficiary—like the data custodian does for the customer. With this setup, companies wishing to do business with a customer will need to get connected through the customer's automated personal assistant, i.e., the data custodian.

In accordance with exemplary embodiments, the personal data custodian of the present invention includes a secure virtual vault for personal data storage combined with a natural language processing and natural language generation AI, which uses blockchain technology to secure all transactions. Further, the data custodian is not shared AI, but AI (such as machine learning or deep neural networks) that is personalized and dedicated to a single user or customer. That is, the data custodian is a personal AI powered assistant or bot that is owned uniquely by a single person. As will be seen, the data custodian represents a customer's “digital twin” who knows the customer's preferences, has access to the customer's data, actively collects and updates such data, handles the customer's personal data just like a monetary asset, and shares that data through established and approved trusted relationships. The data custodian also can act on behalf of the customer, for example, when the customer specifically requests the data custodian to handle a task. Additionally, the data custodian can act proactively, such as by offering to do a task for the customer whenever the collected data indicates that such a task is desirable or in the customer's interests. Such functionality may include the data custodian acting automatically or after asking for permission from the customer before handling the task.

As will be appreciated, in this model, the customer's data is considered and handled as an asset having real monetary value. In exemplary embodiments, the customer has the right to retain or sell (i.e., share) that asset for return value, i.e., for money or in exchange for services or products. In exemplary embodiments, all PII and other data of an individual will be owned, secured and fully controlled solely by that individual or customer, with that individual deciding who or what entities have access to that data or subset of data and what triggers that access. Companies and merchants will need to earn and continuously maintain their trusted relationship with the data guardian of a particular customer. A transparent and mutually trusted way of doing business will be in both parties' primary interest.

Once the customer's personal data is encrypted and placed within the secure repository of the data custodian, the customer can decide on a case by case basis on which organizations, companies, or entities the customer trusts as well as the subset of the customer's personal data can be shared with each of them and the cases under which the sharing can occur. As an example, once the trusted relationship knowledge is established by the customer within the data custodian and the relationships or connections are made with related organizations and enterprises, the data custodian of the present invention can then act on behalf of the customer at times when necessary. In an exemplary case, the customer may request that the data custodian pay the customer's mortgage. The customer's data custodian may ask which accounts the customer would like to use to fulfil the payment request and then receive the customer approval for the money transfer. Once received, the data custodian may connect to the appropriate customer's bank and complete the transaction through the previously established trusted relationship.

As stated, the data custodian of the present invention is not shared between customers. Each instance of the data custodian is an AI enabled application that is trained for interacting with a particular individual, i.e., a particular customer. Thus, the data custodian only handles one set of personal data. The individual instances of the data custodian (including the personal secured data vaults and personal AI assistant) can be implemented in the cloud, but data is not shared outside of the trusted relationship circle unless specially authorized by the customer. Further, from the outside, merchants and marketers may never actually know who the owner of a particular instance of the data custodian is, i.e., who the stored personal data describes and belongs to. In this way, both the marketers' ability and incentive target particular people with marketing messages are greatly curtailed.

Instead, the personal data custodian becomes the arbiter of what marketing messages get presented to the customer, with the determination being based on knowledge directly requested by the customer or gleamed from the personal data stored in the customer's data profile. That is, the personal data custodian will consider what makes sense for the customer it represents as an sort of “algorithmic buyer”, selecting information, messages, and offers related to products and services from those publicly available offers that match one of the customer's interests or current needs. In this way, the data custodian substitutes as the buyer for the customer and deflects much of the bothersome and time-consuming marketing campaigns that target the customer. This setup also serves the interests of reputable, trusted companies that offer quality products and services at reasonable prices, as such companies can reach customers via the data custodian with timely and targeted messages at a fraction of the cost it would take otherwise. For example, in accordance with exemplary embodiments, the data custodian can crawl the web, search, find and compare hundreds or thousands of product offers and can save time for the customer by selecting and proposing the products that best fit the customer's interest or need. In doing this, the data custodian can use public search services to collect not just marketing information about products or services, but also consider independent customer reviews, fault reports, historic information or predicted trends, and loyalty or status related benefits so that a wide range of information is taken into account and the selections made for presenting to the customer are optimized.

In exemplary embodiments, the customer may authorize the sharing of data with trusted entities in several ways. For example, a customer can control their data sharing at a transaction level, i.e., select on a case by case basis what subset of their data is to be shared with what entity in a given transaction. The data custodian can also ask for approval or consent based on a type or classification of a transaction. Customers can also give approval for data share related to a given entity or brand, which may include approval for several different types of transactions with a given entity. This approval can be made for a predetermined period of time or made for an indefinite period. In some business categories and for some customers, trust related to a brand will be more meaningful than price. In other products or service categories, brands may be less relevant. The individual data custodians (i.e., the AI algorithms that run them) will take such differences into consideration. Brands may assess the value of maintaining direct communication with their potential customers through the data custodian. Trust for a brand would be a key differentiator that delivers advantages to those companies that can better manage their relationship with the data custodian.

With specific reference to FIG. 10, a schematic diagram is shown of a system 700 that includes a personal data custodian 705 in accordance with the present invention. As shown, the data custodian 705 may include a personal AI assistant (or simply personal assistant) 710 and a secured data vault 715. As already described, the data custodian 705 may serve as an intermediary between a particular customer 720 and various organizations or entities 725, which may include companies, groups, enterprises, individuals, etc. The data custodian 705 may share personal data stored within the secured data vault 705 with the entities 725 pursuant to instructions received from the customer 720. The customer 720 may deliver such instructions to personal assistant interfaces implemented through a variety of personal electronic devices.

In FIG. 11, the data custodian 705 is shown in greater detail. As shown, along with the components already introduced, the data custodian 705 may include several other modules. In accordance with exemplary embodiments, the function of these components and modules will now be discussed.

According to exemplary embodiments, the secure data vault 715 stores sensitive or personal customer data in an encrypted storage facility that is accessible by the personal assistant 710. Such data may include any of the types described herein. Each element of such data may be stored and secured separately such that a single compromised item does not result in the other items being compromised. Service may be fulfilled by a third party through an API or similar integration. Changes to the customer's data will leverage a distributed ledger, block chain or similar secure transaction management to ensure data has not been changed without consent. Ephemeral data may also be secured/encrypted but, where possible, not stored and is disposed of immediately after use. Metadata within the system is similarly secured and treated as private information.

In accordance with exemplary embodiments, one of the modules included in the data custodian 705 is a behavior recognition engine 740. The behavior recognition engine 740 detects and analyzes previous conditions and the decisions or actions taken by the customer in response to those conditions. This analysis is done in order to find patterns in the data that can be generalized into customer insights or predictors which are then used to predict future decisions and actions of the customer and/or the customer's preferences so that the automation provided by the personal assistant 710 can be more targeted and helpful to the customer. Such predictors are stored as a type of customer data in the secure data vault 715. In exemplary embodiments, such predictors feed into the customer preferences and interest profile stored within a dynamic customer profile that is maintained in the secure data vault 715.

As an example, if given a choice between electronic equipment brands, a customer is found to most often choose Sony and the data of these transactions are recorded and stored in the secure data vault 715, then an insight or predictor for the customer may be gleamed from the data and then stored as a customer preference for that brand. This preference may be recorded in reference to a domain (which, in this case, may be classified as “equipment purchases”), a topic (which, in this case, may be designated “electronic equipment”), and an attribute (which, in this case, may be designated “preferred brand =Sony”). Such data insights or patterns may be recognized using any of the methods described herein, for example, those disclosed above in relation to the discussion related to the predictive models developed in the analytics module 250 as well as the discussion related to the interaction predictors developed for a personalized customer profile 330. As stated, the customer data is dynamically maintained such that predictors determined for a customer by the personal AI assistant 710 remain applicable to the customer only so long as the totality of the data, including new inputs, support the inference. Once the new inputs result in the data no longer supporting a predictor, the predictor will be deleted or modified to bring it in line with the data.

In accordance with exemplary embodiments, another module included in the data custodian 705 is a preference builder 745. The preference builder 745 is responsible for recognizing, building, and maintaining a set of expressed or inferred attributes that describe the customers interests and/or preferences in one or more topics. Preferences or interests may be determined for a customer via direct input by the customer or inferred from the data. As stated, the behavior recognition engine may infer preferences and interests, as described above. A customer's interest or preference profile may be broken up into one or more domains of similar topics such that interests may be shared across domains or be exclusive to one. As an example, an “aisle” seating preference may apply to multiple domains, such as “air travel” and “concerts”. Such a preference can be combined with modifiers, such as traveling with friends and family, and this may result in a change to a preference such that an “aisle” preference becomes a “center” preference. The interest profile attributes, topics and domains may be temporary, conditional, permanent, or situational. Further, the personal assistant 710 may ask questions of the customer to illicit interest and preferences to learn new conditions or attributes related to particular topics and domains.

In accordance with exemplary embodiments, another module included in the data custodian 705 is a policy manager 750. The policy manager 750 is responsible for rules of engagement 755 (also referred to as “engagement rules”), which are depicted in the figure between the personal assistant 710 and the secure data vault 715. The rules of engagement 755 represents strict conditions that must be adhered to before the personal assistant 710 acts on behalf of the customer, e.g., completing a financial transaction with a trusted entity or sharing personal data. The rules of engagement 755 govern the personal assistant's 710 use of and access to the customer data maintained in the secure data vault 715. The rules of engagement 755 are configured so that they cannot be avoided or made to violated by any of the suggestions or predictors or the express instructions of the customer. For example, ROE may include such conditions as:

Must not purchase items over $50 without obtaining customer's permission;

Must not schedule any meetings after 5 PM without customer's permission;

Must confirm reservations with customer before booking;

Max price for hotel room without obtaining customer's permission.

Other subsystems within the data custodian 705 may be used to determine multiple options. For example, available hotel rooms ranging in price from $200 to $400 may be searched by the data custodian. Once all other preference conditions are met so that the workable options are known, policies or rules of engagement 755 maintained within the policy manager would then exclude any options that are outside of the core policy. According to exemplary embodiments, the customer profile is a set of attributes that the data custodian 705 uses to determine the rules of engagement.

In accordance with exemplary embodiments, another module included in the data custodian 705 is a virtual identity manager 760. As will be appreciated, there can arise a need for the data custodian 705 to act in an anonymous way to protect the customer from unwanted identification by third parties. Additionally there may be a need to determine which identifiers are used by certain their parties, for example if “random@PAdomain.com” is supplied to a vendor for the purpose of identification, any resulting correspondence to this email address can be attributed to that vendor, including all data sharing that the vendor has performed (wanted or unwanted). In this way the system can be considered an identity proxy. Similarly, an identification token could take the form of any unique identifier assigned to the customer. The virtual identity manager 760 is configured to deal with these issues. Thus, the virtual identity manager 760 may be configured to create, read, update and delete virtual identity tokens by all authorized parties and systems. Further, the virtual identity manager 760 may create, assign, and disposal of temporary, unique or expungable identification tokens. As an example, the virtual identity manager 760 may create, assign, and dispose of a phone number for use by the personal assistant 710 to complete a transaction with a “brick and mortar” store. Also, the virtual identity manager 760 may create, assign, and dispose of an email address for use by the personal assistant.

In accordance with exemplary embodiments, another module included in the data custodian 705 is an outcome optimizer and risk manager 765. The outcome optimizer and risk manager 765 allows the personal assistant 710 to act on the customer's behalf to achieve either a predetermined or derived goal, where predetermined goals are those that are explicit or stated objectives and inferred goals those that are not explicitly stated by the customer but deduced by statements related to other goals and other data. This module is also responsible for the calculation of the risk versus benefit analysis in support of the goal. For example, the goal may be achieved by multiple strategies that carry a varying amount of risk. This module seeks to deliver an optimal decision to the customer considering all factors that can be known or reasonably predicted. For example, in selecting the best airline flight, there may be several options given a set of constrains. The outcome optimizer and risk manager 765 may find that there are two flights that satisfy the customers objectives, one at 1:00 PM and another at 10:00 PM, however flights that depart at 10:00 PM have a higher cancelation rate and hence the risk profile of this flight is considered higher. This is weighed in deciding which flight to book, particularly in light of the customer goal of needing to be at an appointment in the destination city early in the day following the flight.

In accordance with exemplary embodiments, another module included in the data custodian 705 is a schedule manager 770. The schedule manager 770 may look at incoming items and events and coordinate them in accordance with the customer's schedule. Via the functionality of the schedule manager 760, the personal assistant 710 may be able to accept meetings, block time, or reject and respond to the external entity requests with or without consulting the customer.

In accordance with exemplary embodiments, another module included in the data custodian 705 is a relationship manager 775. The relationship manager 775 correlates the significance of the relationships between one or more entities. The objective of this module is to determine which of the relationships with entities are trusted, including which merchants are favored or default merchants for certain goods. Another objective is to track interpersonal relationships with the customer, including determining who is the customer's family and friends, and who are the customer's colleagues/business partners.

In accordance with exemplary embodiments, another module included in the data custodian 705 is an interest profile manager 780. The interest profile manager 780 is responsible for exposing customer preferences during moments of engagement. To do this, this module interacts with the preference builder 745 and behavioral recognition engine 740 to make selections.

In accordance with exemplary embodiments, another module included in the data custodian 705 is a tradeoff manager 785. The tradeoff manager 785 is configured as a sophisticated recommendation engine with continuous machine learning capability. This module is responsible for evaluating the set of possibilities and presenting alternative and substitution options by relaxing one or more of the constraints. In this way, the tradeoff manager 785 provides the customer with the set of possibilities that benefit the customer most according to the interest profile. The tradeoff manager 785 uses past experiences and preferences to determine tradeoff possibilities. Additionally, the tradeoff manager 785 uses risk assessment as a key input to the evaluation of the tradeoff options to determine the ideal set of candidate options

In accordance with exemplary embodiments, another module included in the data custodian 705 is a multi-party computing engine 790. The multi-party computing engine 790 enables two or more persons or entities to jointly perform a computation without disclosing any of the participants' private inputs. The participants agree on a function to compute, and then can use an “MPC” protocol to jointly compute the output of that function on their secret inputs without revealing those inputs. The goal the multi-party computing engine 790 is to enable parties to jointly compute a function over their inputs while keeping those inputs private. For example, if the customer wishes to inform an entity of their credit worthiness without disclosing their total income, each party may trade information that individually is not useful, but after computing may yield the customer's credit score. The customer's income remains private, yet both parties are able trust in the result because of the functionality provided by the multi-party computing engine 790.

In accordance with exemplary embodiments, another module included in the data custodian 705 is a secured transaction manager 795. The role of the secure transaction manager 795 is to monitor the encrypted data sharing transactions between the parties and ensure the integrity of the communications. This module manages the distributed ledger, e.g., the blockchain records and is also responsible for transaction reporting. This module may be configured to handle multiple transaction processing in an asynchronous mode.

In exemplary operation, the personal data custodian may function as part of a method or system for personalizing protection of personal data pursuant to behavioral factors unique to an individual customer (hereafter “first customer”). The behavioral factors may be learned from transaction data describing respective transactions occurring between the first customer and entities via a communication device of the first customer. The method may include: storing, in a secured data vault, a customer profile of the first customer that includes personal data of the first customer and the transaction data from each of the transactions; providing a personal assistant application (hereafter “personal assistant”) accessible to the first customer via the communication device, wherein the personal assistant is configured to access the personal data of the first customer in the customer profile pursuant to engagement rules in order to conduct the transactions with the entities on behalf of the first customer; updating the customer profile pursuant to newly occurring ones of the transactions (hereafter “new transactions”), the new transactions including a first new transaction occurring between the first customer and a first one of the entities (hereafter “first entity”); generating a predictor from the updated customer profile, the predictor including knowledge about the first customer derived, at least in part, from the data stored within the updated customer profile, the knowledge including a first one of the behavioral factors (hereafter “first behavioral factor”) attributable to the first customer given a characteristic related to the first new transaction; augmenting the customer profile by storing therein the predictor, wherein the predictor: modifies at least one of the rules of the engagement rules and links the behavioral factor to the characteristic of the first transaction; detecting the characteristic as being present in an incoming one of the transactions (hereafter “incoming transaction”) involving a second one of the entities (hereafter “second entity”); and modifying, in accordance with the behavioral factor of the predictor, a manner in which the personal assistant conducts the incoming interaction with the second entity on behalf of the first customer.

In exemplary embodiments, the personal assistant may conduct each of the transactions via selectively sharing aspects of the personal data of the first customer with the entities so to maximize an anonymity of the first customer relative to the entities. The maximizing the anonymity of the first customer includes limiting the sharing of personally identifiable information of the first customer stored in the customer profile. The personal assistant includes natural language processing and natural language generation capabilities for conducting interactions with the first customer via the communication device. The incoming transaction may relate to a direct request made by the first customer to the personal assistant using the natural language processing capabilities. Alternatively, the incoming transaction may relate to a probable need of the first customer identified by the personal assistant from a condition derived from data stored in the updated customer profile. The engagement rules may include a trusted relationship log that records a relationship status existing between the first customer and each of the entities. As part of the relationship status, the relationship log may describe: a subset of the personal data of the first customer that is permitted to be shared with each of the entities; and circumstances under which the sharing of the subset of the personal data is permitted with each of the entities. The entities may be companies that produce products. The behavioral factors may be preferences of the first customer and/or interests of the first customer. The method may further include: receiving marketing messages from the respective companies; filtering the marketing messages based the behavioral factors so to derive a filtered set of marketing messages; and presenting the filtered set of marking messages to the first customer. The method may further include: generating, by the personal assistant, one or more user interfaces on a display of the communication device that prompt the first customer for input regarding a clarification related to one of the preferences or one of the interests; receiving, by the personal assistant, input from the first customer related to the clarification; and updating, by the automated assistant, the customer profile in accordance with the input received from the first customer. The predictor may be generated by a first subprocess that includes the steps of: identifying a dataset that includes the transaction data stored within the customer profile of other transactions, the other transactions being selected based on having a transaction category that is the same as the first new transaction; and deriving the knowledge of the predictor by applying a machine learning algorithm to the dataset to identify patterns therein correlating one or more input factors to one or more outcomes relevant to the transaction category.

As has been seen, the advantages associated with the functionality enabled by the data custodian are several. First, the data custodian empowers customers to own, control and share their own personal data based on their own interests in a same way as they are owning and controlling their financial assets. The customer of a data custodian can decide whenever they want to disclose, share, or even sell a subset of their personal or transactional data in the marketplace. Further, the data custodian can crawl the web, search, find and compare hundreds or thousands of offers and can save tremendous amount of time and effort to its customers by selecting and proposing the product or a service which fits the customer's preferences best. The data custodian of the present invention further can use public search services to collect information not just about the demanded products or services, but concerning independent customer reviews, fault reports, historic information or predicted trends, loyalty or status related benefits in order to select and offer the best possible product or service to its beneficiary customer.

The data custodian also makes sure that the customer is aware and able to control what data is involved in each transaction with outside entities. However, in many cases, the data custodian enables transactions without having to share any personal data of the customer. When transactions do require some subset of the customer's data to be shared with a service provider (e.g. when the customer orders a service that is performed on the customer's home, the sharing of the customer's address is required), the data custodian can ensure the all other personal data remains secure. That is, the data custodian will pay the provider of the service via the customer's bank through the customer's trusted account, so the customer's other personal data, like the customer's name, the customer's credit card number, etc. is not need to be shared.

Finally, as more digital transactions are performed by “digital twins” such as the data custodian, merchants and marketers will need to focus more on how to attract these new (non-human) buyers. Merchants will need to advertise their products and services in a different way. They will need to understand the selection criteria of the individual algorithmic buyers rather than try to track and directly target their beneficiary humans. In the beginning customers will use their data custodian to direct purchasing methods together, but as their data custodian proves its effectiveness across multiple use cases, customers will begin to use data custodians for an increasing number of interactions. As the data custodian considers benefits to the customer based primarily on objective criteria, a customer's purchasing decisions will improve. The old tricks and techniques that marketers relied on to sway human buyers into making impulsive or unwise decisions will hold little sway when confronted by the customers more analytic digital twin.

As one of skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, each of the possible iterations is not provided or discussed in detail, though all combinations and possible embodiments embraced by the several claims below or otherwise are intended to be part of the instant application. In addition, from the above description of several exemplary embodiments of the invention, those skilled in the art will perceive improvements, changes and modifications. Such improvements, changes and modifications within the skill of the art are also intended to be covered by the appended claims. Further, it should be apparent that the foregoing relates only to the described embodiments of the present application and that numerous changes and modifications may be made herein without departing from the spirit and scope of the present application as defined by the following claims and the equivalents thereof

That which is claimed:

1. A computer-implemented method for personalizing protection of personal data pursuant to behavioral factors unique to an individual customer (hereafter “first customer”), the behavioral factors being learned from transaction data describing respective transactions occurring between the first customer and entities via a communication device of the first customer, the method comprising:
storing, in a secured data vault, a customer profile of the first customer that comprises:
personal data of the first customer; and
the transaction data from each of the transactions;
providing a personal assistant application (hereafter “personal assistant”) accessible to the first customer via the communication device, wherein the personal assistant is configured to access the personal data of the first customer in the customer profile pursuant to engagement rules in order to conduct the transactions with the entities on behalf of the first customer;
updating the customer profile pursuant to newly occurring ones of the transactions (hereafter “new transactions”), the new transactions including a first new transaction occurring between the first customer and a first one of the entities (hereafter “first entity”);
generating a predictor from the updated customer profile, the predictor comprising knowledge about the first customer derived, at least in part, from the data stored within the updated customer profile, the knowledge comprising a first one of the behavioral factors (hereafter “first behavioral factor”) attributable to the first customer given a characteristic related to the first new transaction;
augmenting the customer profile by storing therein the predictor, wherein the predictor: modifies at least one of the rules of the engagement rules and links the behavioral factor to the characteristic of the first transaction;
detecting the characteristic as being present in an incoming one of the transactions (hereafter “incoming transaction”) involving a second one of the entities (hereafter “second entity”); and
modifying, in accordance with the behavioral factor of the predictor, a manner in which the personal assistant conducts the incoming interaction with the second entity on behalf of the first customer.

2. The method of claim 1, wherein the personal assistant conducts each of the transactions via selectively sharing aspects of the personal data of the first customer with the entities so to maximize an anonymity of the first customer relative to the entities.

3. The method of claim 2, wherein the maximizing the anonymity of the first customer comprises limiting the sharing of personally identifiable information of the first customer stored in the customer profile.

4. The method of claim 1, wherein the secure data vault is secured via block chain technology; and
wherein the secure data vault is accessible only by the personal assistant.

5. The method of claim 1, wherein the personal assistant comprises natural language processing and natural language generation capabilities for conducting interactions with the first customer via the communication device; and
wherein the incoming transaction relates to a direct request made by the first customer to the personal assistant using the natural language processing capabilities.

6. The method of claim 1, wherein the incoming transaction relates to a probable need of the first customer identified by the personal assistant from a condition derived from data stored in the updated customer profile.

7. The method of claim 1, wherein the engagement rules comprise a trusted relationship log that records a relationship status existing between the first customer and each of the entities; and wherein, as part of the relationship status, the relationship log describes:
a subset of the personal data of the first customer that is permitted to be shared with each of the entities; and
circumstances under which the sharing of the subset of the personal data is permitted with each of the entities.

8. The method of claim 1, wherein the entities comprise companies that produce products;
wherein the behavioral factors comprise at least one of:
preferences of the first customer; and
interests of the first customer;
further comprising:
receiving marketing messages from the respective companies;
filtering the marketing messages based the behavioral factors so to derive a filtered set of marketing messages; and
presenting the filtered set of marking messages to the first customer.

9. The method of claim 1, further comprising:
generating, by the personal assistant, one or more user interfaces on a display of the communication device that prompt the first customer for input regarding a clarification related to one of the preferences or one of the interests;
receiving, by the personal assistant, input from the first customer related to the clarification; and
updating, by the automated assistant, the customer profile in accordance with the input received from the first customer.

10. The method of claim 1, wherein the predictor is generated by:
identifying a dataset that includes the transaction data stored within the customer profile of other transactions, the other transactions being selected based on having a transaction category that is the same as the first new transaction; and
deriving the knowledge of the predictor by applying a machine learning algorithm to the dataset to identify patterns therein correlating one or more input factors to one or more outcomes relevant to the transaction category.

11. A system for personalizing protection of personal data pursuant to behavioral factors unique to an individual customer (hereafter “first customer”), the behavioral factors being learned from transaction data describing respective transactions occurring between the first customer and entities via a communication device of the first customer, the system comprising:
a hardware processor; and
a machine-readable storage medium on which is stored instructions that cause the hardware processor to execute a process, wherein the process comprises the steps of:
storing, in a secured data vault, a customer profile of the first customer that comprises:
personal data of the first customer; and
the transaction data from each of the transactions;
providing a personal assistant application (hereafter “personal assistant”) accessible to the first customer via the communication device, wherein the personal assistant is configured to access the personal data of the first customer in the customer profile pursuant to engagement rules in order to conduct the transactions with the entities on behalf of the first customer;
updating the customer profile pursuant to newly occurring ones of the transactions (hereafter “new transactions”), the new transactions including a first new transaction occurring between the first customer and a first one of the entities (hereafter “first entity”);
generating a predictor from the updated customer profile, the predictor comprising knowledge about the first customer derived, at least in part, from the data stored within the updated customer profile, the knowledge comprising a first one of the behavioral factors (hereafter “first behavioral factor”) attributable to the first customer given a characteristic related to the first new transaction;
augmenting the customer profile by storing therein the predictor, wherein the predictor: modifies at least one of the rules of the engagement rules and links the behavioral factor to the characteristic of the first transaction;
detecting the characteristic as being present in an incoming one of the transactions (hereafter “incoming transaction”) involving a second one of the entities (hereafter “second entity”); and
modifying, in accordance with the behavioral factor of the predictor, a manner in which the personal assistant conducts the incoming interaction with the second entity on behalf of the first customer.

12. The system of claim 11, wherein the personal assistant conducts each of the transactions via selectively sharing aspects of the personal data of the first customer with the entities so to maximize an anonymity of the first customer relative to the entities.

13. The system of claim 12, wherein the maximizing the anonymity of the first customer comprises limiting the sharing of personally identifiable information of the first customer stored in the customer profile.

14. The system of claim 11, wherein the secure data vault is secured via block chain technology; and
wherein the secure data vault is accessible only by the personal assistant.

15. The system of claim 11, wherein the personal assistant comprises natural language processing and natural language generation capabilities for conducting interactions with the first customer via the communication device; and
wherein the incoming transaction relates to a direct request made by the first customer to the personal assistant using the natural language processing capabilities.

16. The system of claim 11, wherein the incoming transaction relates to a probable need of the first customer identified by the personal assistant from a condition derived from data stored in the updated customer profile.

17. The system of claim 11, wherein the engagement rules comprise a trusted relationship log that records a relationship status existing between the first customer and each of the entities; and
wherein, as part of the relationship status, the relationship log describes:
a subset of the personal data of the first customer that is permitted to be shared with each of the entities; and
circumstances under which the sharing of the subset of the personal data is permitted with each of the entities.

18. The system of claim 11, wherein the entities comprise companies that produce products;
wherein the behavioral factors comprise at least one of:
preferences of the first customer; and
interests of the first customer;
wherein the process further comprises the step of:
receiving marketing messages from the respective companies;
filtering the marketing messages based the behavioral factors so to derive a filtered set of marketing messages; and
presenting the filtered set of marking messages to the first customer.

19. The system of claim 11, wherein the process further comprises the step of:
generating, by the personal assistant, one or more user interfaces on a display of the communication device that prompt the first customer for input regarding a clarification related to one of the preferences or one of the interests;
receiving, by the personal assistant, input from the first customer related to the clarification; and
updating, by the automated assistant, the customer profile in accordance with the input received from the first customer.

20. The system of claim 11, wherein the predictor is generated by the steps of:
identifying a dataset that includes the transaction data stored within the customer profile of other transactions, the other transactions being selected based on having a transaction category that is the same as the first new transaction; and
deriving the knowledge of the predictor by applying a machine learning algorithm to the dataset to identify patterns therein correlating one or more input factors to one or more outcomes relevant to the transaction category.
